(19) United States
(12) Patent Application Publication
(10) Pub. No.: US 2025/0175901 A1
(43) Pub. Date: May 29, 2025

(54) METHOD AND SYSTEM FOR UTILIZING ENERGY-EFFICIENT PROTOCOLS FOR POWER MANAGEMENT FOR A-IOT

(71) Applicant: MEDIATEK INC., Hsinchu (TW)

(72) Inventors: Chien-Chun CHENG, Hsinchu (TW); Chiao-Yao Chuang, Hsinchu (TW); Wei-De Wu, Hsinchu (TW); CHIOU-WEI TSAI, Hsinchu (TW); Tai-Cheng Tsai, Hsinchu (TW)

(21) Appl. No.: 18/941,149

(22) Filed: Nov. 8, 2024

Related U.S. Application Data
(60) Provisional application No. 63/602,687, filed on Nov. 27, 2023.

(51) Int. Cl. H04W 52/02; H04W 56/00

(52) U.S. Cl. CPC H04W 52/0245; H04W 56/0015

(57) ABSTRACT

In an aspect of the disclosure, a method, a computer-readable medium, and an apparatus are provided. The apparatus may be a reader device. The reader device sends a communication initiation signal to an ambient Internet of Things (A-IoT) device. The reader device receives charging status information from the A-IoT device. The reader device adjusts a behavior based on the charging status information.

### CROSS-REFERENCE TO RELATED APPLICATION(S)

This application claims the benefits of U.S. Provisional Application Ser. No. 63/602,687, entitled “Method and System for Utilizing Energy-Efficient Protocols for Power Management for A-IoT” and filed on Nov. 27, 2023, which is expressly incorporated by reference herein in its entirety.

### BACKGROUND

### Field

The present disclosure is generally related to mobile communications and, more particularly, to methods and systems for improving the communication range, power consumption, and charging time for Ambient Internet of Things (A-IoT) devices with respect to user equipment (UE) and network apparatus in mobile communications.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a reader device. The reader device sends a communication initiation signal to an ambient Internet of Things (A-IoT) device. The reader device receives charging status information from the A-IoT device. The reader device adjusts a behavior based on the charging status information.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7(A) is a diagram illustrating an example wireless communication system including a base station and a UE.

FIG. 7(B) is a diagram illustrating an example communication link between a gNB and an A-IoT device though a connection with a UE via a wired cable.

FIG. 7(C) is a diagram illustrating an example communication link between a gNB and an A-IoT device though a connection with a UE via a wireless air interface.

FIG. 7(D) is a diagram illustrating a first type of an A-IoT device.

FIG. 7(E) is a diagram illustrating a second type of an A-IoT device.

FIG. 7(F) is a diagram illustrating a third type of an A-IoT device.

FIG. 7(G) is a diagram illustrating an example communication link between a UE and an A-IoT device via an air interface.

FIG. 7(H) is a diagram illustrating an example communication process between a UE reader/gNB and an A-IoT device based on a chosen time duration.

FIG. 7(I) is a sequence diagram that describes a modified 4-step RACH procedure.

FIG. 7(J) is a sequence diagram that describes a modified 2-step RACH procedure.

FIG. 7(K) is a sequence diagram that describes a modified RACH procedure where a UE acts as a tag reader.

FIG. 7(L) is a sequence diagram that describes a modified Sidelink procedure.

FIG. 8(A) is a diagram illustrating an issue of charging time.

FIG. 8(B) is a diagram illustrating management of charging time using shortened feedback signals.

FIG. 9(A) is a sequence diagram that describes a modified 4-step RACH procedure regarding shortened feedback signals.

FIG. 9(B) is a sequence diagram that describes a modified 2-step RACH procedure regarding shortened feedback signals.

FIG. 9(C) is a sequence diagram that describes a modified RACH procedure where a UE acts as a tag reader regarding shortened feedback signals.

FIG. 9(D) is a sequence diagram that describes a modified Sidelink procedure regarding shortened feedback signals.

FIG. 10(A) is a sequence diagram that describes a modified 4-step RACH procedure regarding a charging status in RN16.

FIG. 10(B) is a sequence diagram that describes a modified 2-step RACH procedure regarding a charging status in RN16.

FIG. 10(C) is a sequence diagram that describes a modified RACH procedure where a UE acts as a tag reader regarding a charging status in RN16.

FIG. 10(D) is a sequence diagram that describes a modified Sidelink procedure regarding a charging status in RN16.

FIG. 11(A) is a sequence diagram that describes a modified 4-step RACH procedure regarding scheduled inquiry commands.

FIG. 11(B) is a sequence diagram that describes a modified 2-step RACH procedure regarding scheduled inquiry commands.

FIG. 11(C) is a sequence diagram that describes a modified RACH procedure where a UE acts as a tag reader regarding scheduled inquiry commands.

FIG. 11(D) is a sequence diagram that describes a modified Sidelink procedure regarding scheduled inquiry commands.

FIG. 12(A) is a sequence diagram that describes a modified 4-step RACH procedure regarding adaptive ACK timing.

FIG. 12(B) is a sequence diagram that describes a modified 2-step RACH procedure regarding adaptive ACK timing.

FIG. 12(C) is a sequence diagram that describes a modified RACH procedure where a UE acts as a tag reader regarding adaptive ACK timing.

FIG. 12(D) is a sequence diagram that describes a modified Sidelink procedure regarding adaptive ACK timing.

FIG. 13(A) is a sequence diagram that describes a modified 4-step RACH procedure regarding a charging status in EPC.

FIG. 13(B) is a sequence diagram that describes a modified 2-step RACH procedure regarding a charging status in EPC.

FIG. 13(C) is a sequence diagram that describes a modified RACH procedure where a UE acts as a tag reader regarding a charging status in EPC.

FIG. 13(D) is a sequence diagram that describes a modified Sidelink procedure regarding a charging status in EPC.

FIG. 14(A) is a sequence diagram that describes a modified 4-step RACH procedure regarding multiple RN16 signals.

FIG. 14(B) is a sequence diagram that describes a modified 2-step RACH procedure regarding multiple RN16 signals.

FIG. 14(C) is a sequence diagram that describes a modified RACH procedure where a UE acts as a tag reader regarding multiple RN16 signals.

FIG. 14(D) is a sequence diagram that describes a modified Sidelink procedure regarding multiple RN16 signals.

FIG. 15(A) is a sequence diagram that describes a modified 4-step RACH procedure regarding delaying data transfer.

FIG. 15(B) is a sequence diagram that describes a modified 2-step RACH procedure regarding delaying data transfer.

FIG. 15(C) is a sequence diagram that describes a modified RACH procedure where a UE acts as a tag reader regarding delaying data transfer.

FIG. 15(D) is a sequence diagram that describes a modified Sidelink procedure regarding delaying data transfer.

FIG. 16(A) is a sequence diagram that describes a modified 4-step RACH procedure regarding energy efficient protocols.

FIG. 16(B) is a sequence diagram that describes a modified 2-step RACH procedure regarding energy efficient protocols.

FIG. 16(C) is a sequence diagram that describes a modified RACH procedure where a UE acts as a tag reader regarding energy efficient protocols.

FIG. 16(D) is a sequence diagram that describes a modified Sidelink procedure regarding energy efficient protocols.

FIG. 17 illustrates an example communication system having an example communication apparatus and an example network apparatus.

FIG. 18(A) is a flow chart of a process for handling charging time regarding a reader device and an A-IoT device.

FIG. 18(B) is a flow chart of another process for handling charging time regarding a reader device and an A-IoT device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

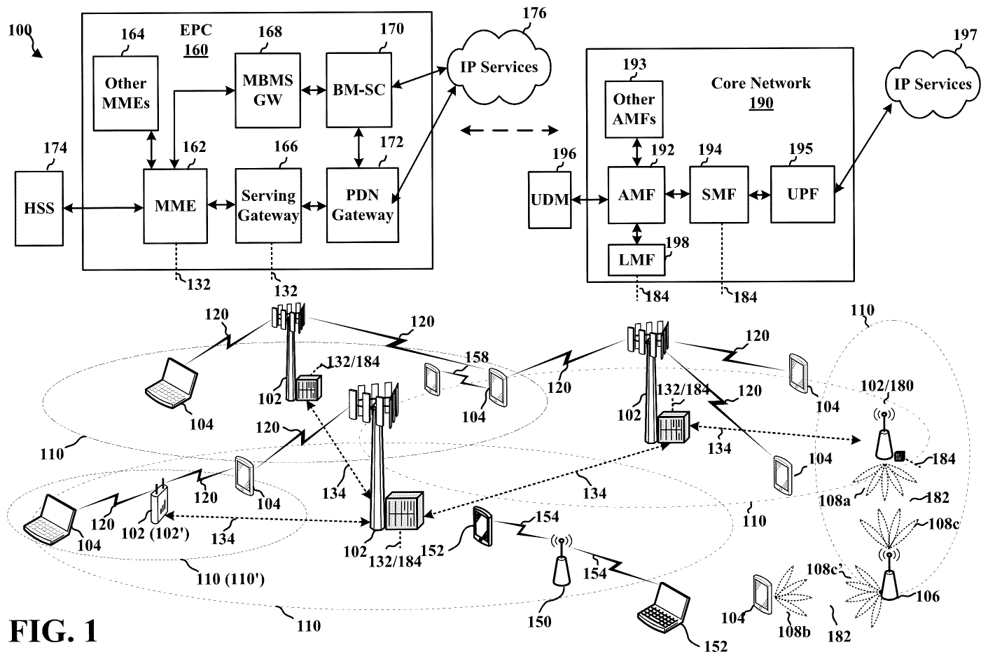

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mm W or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

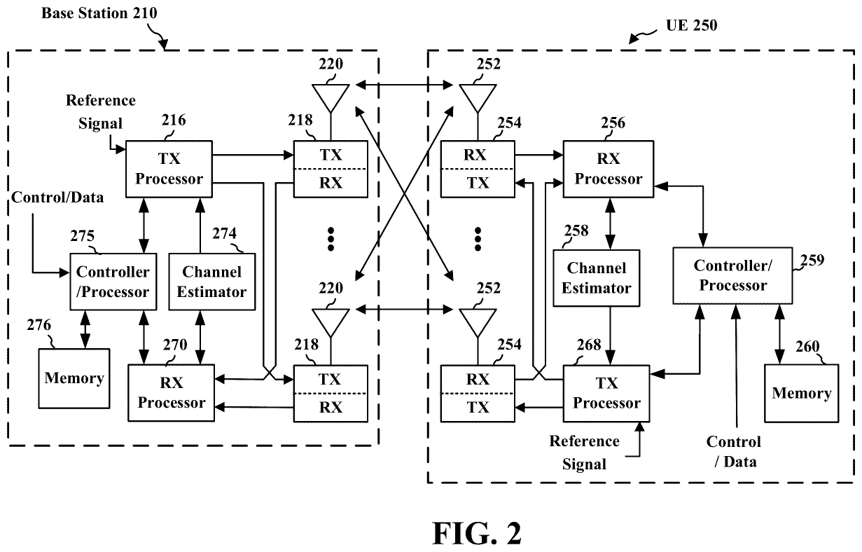

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

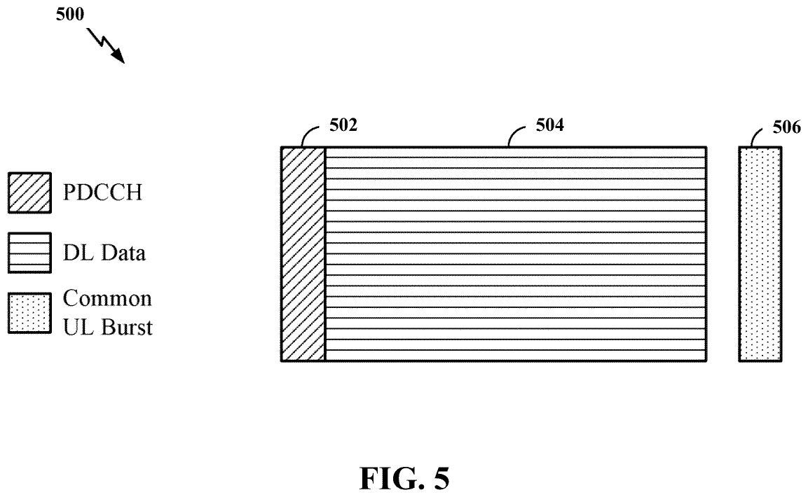

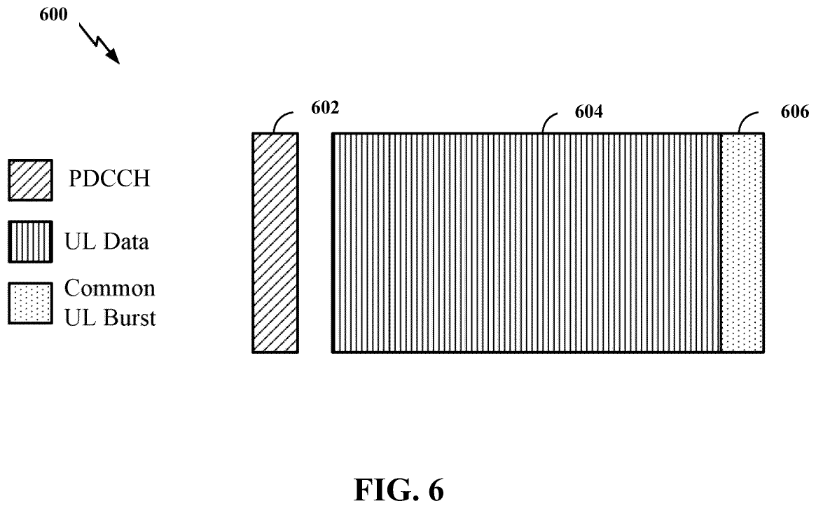

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

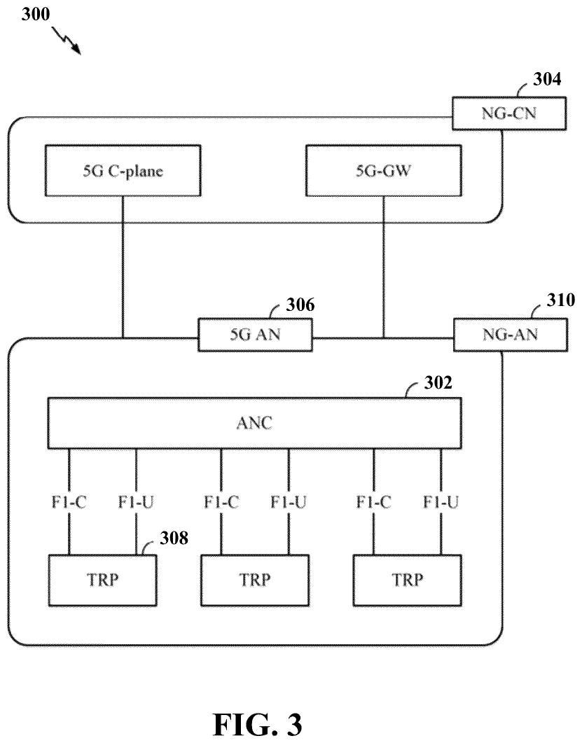

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

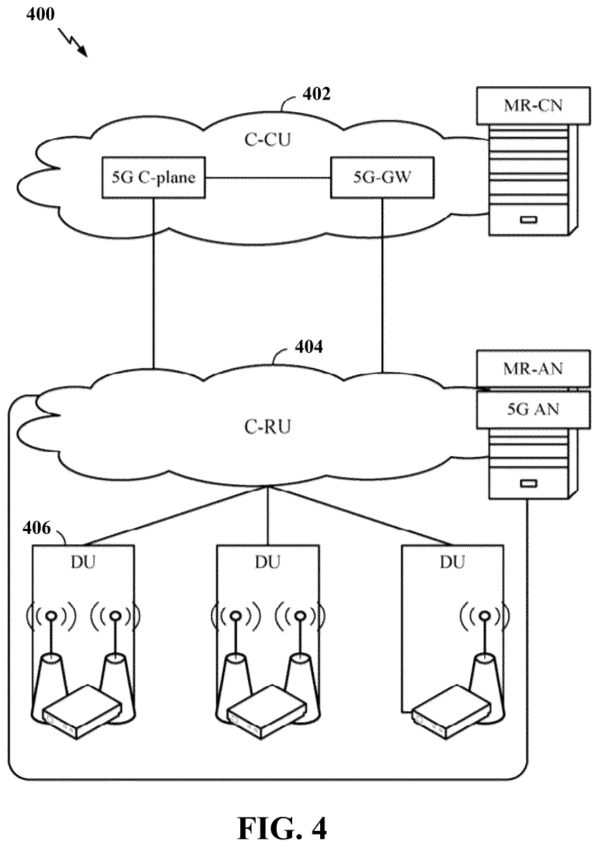

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

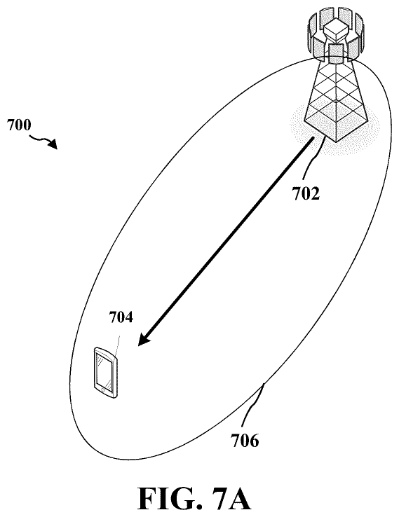

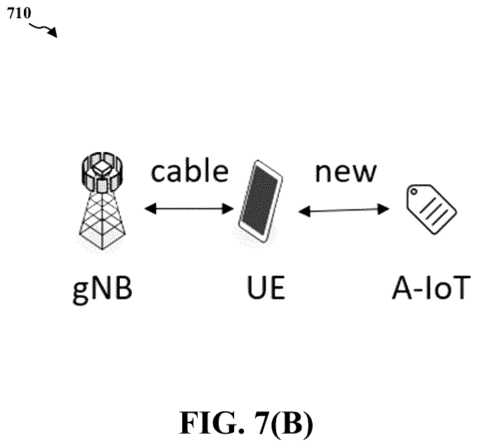

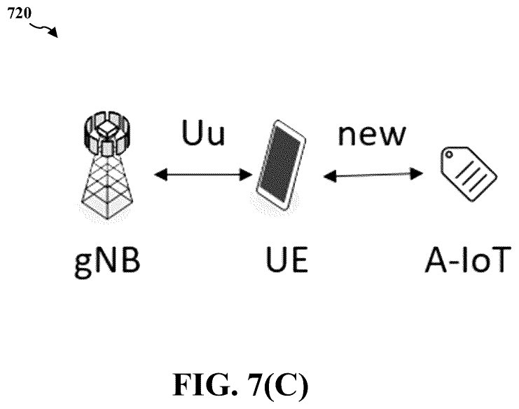

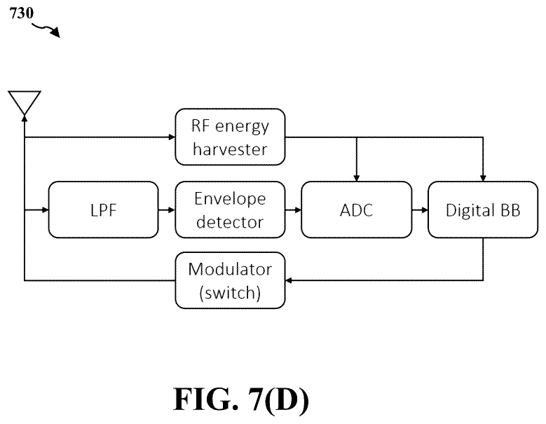

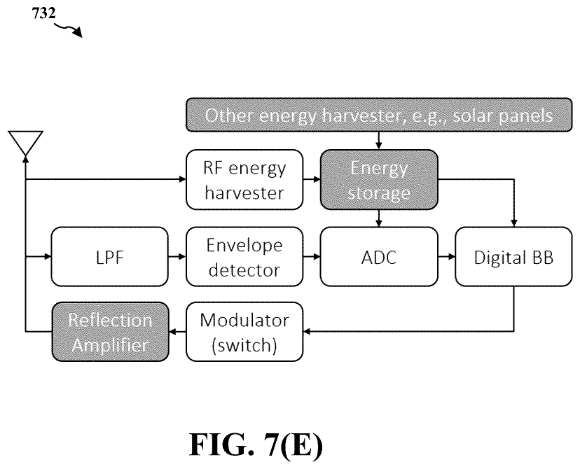

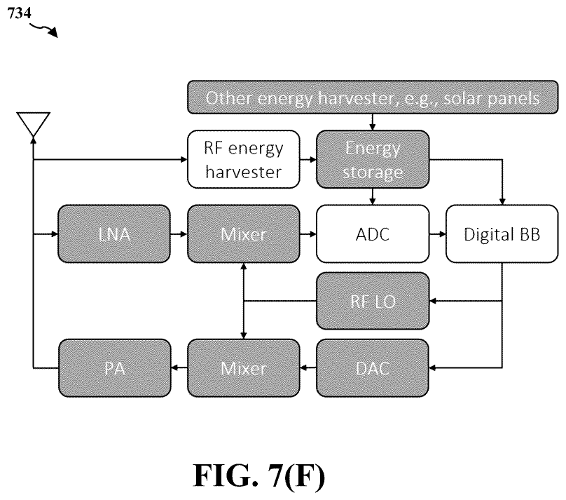

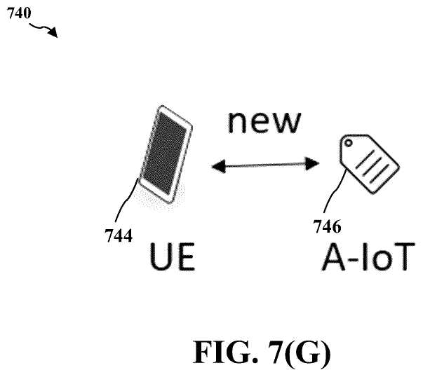

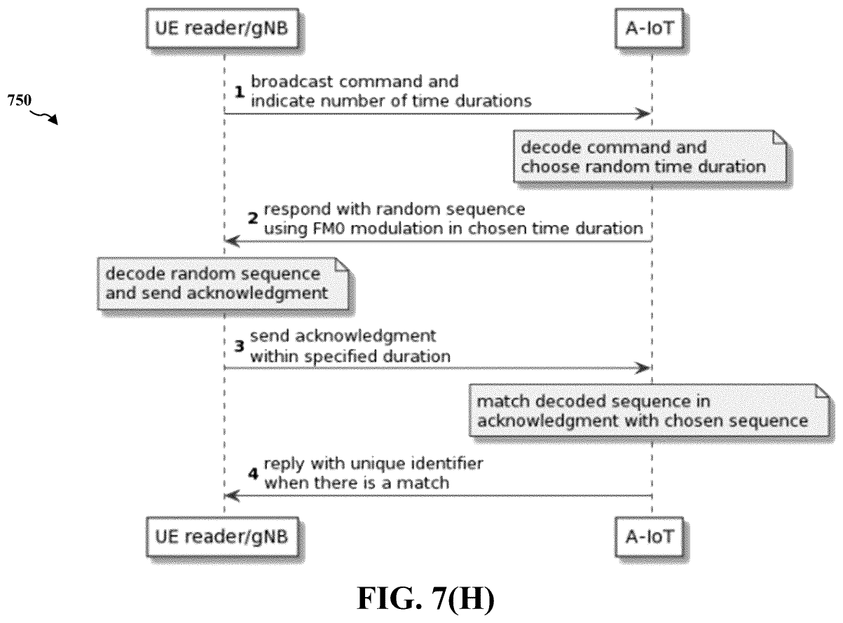

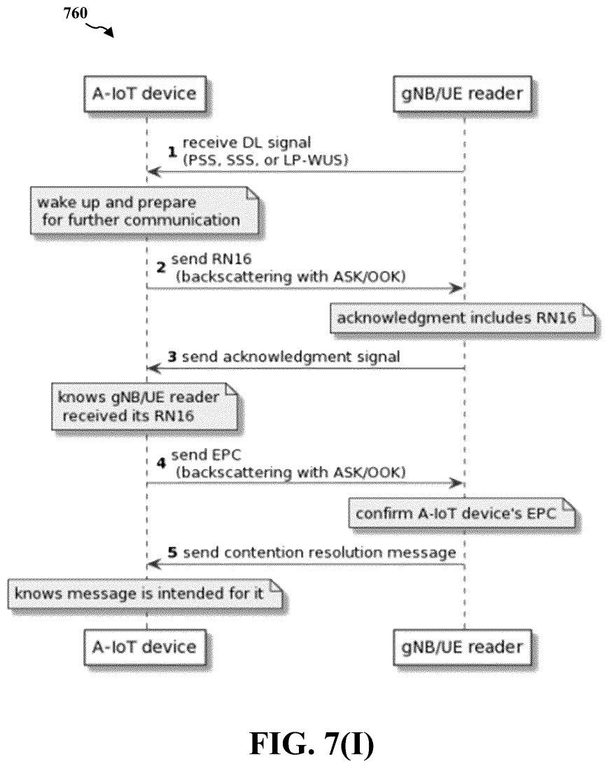

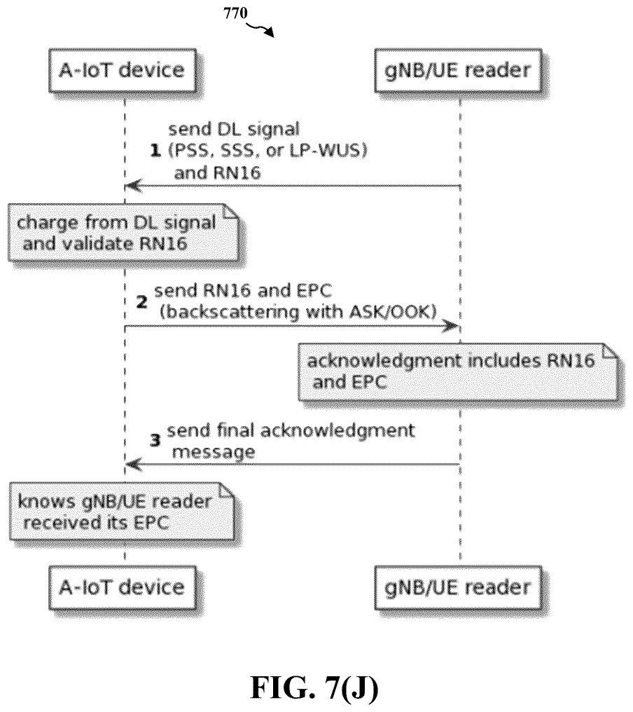

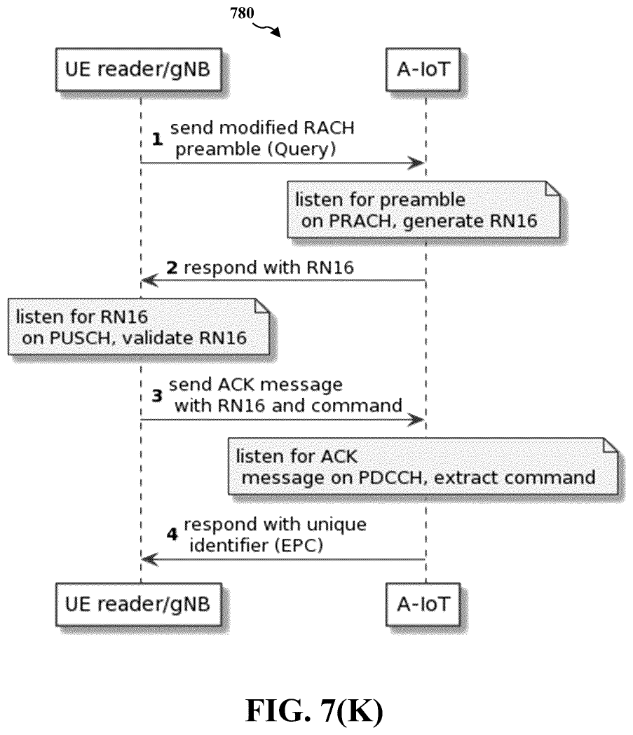

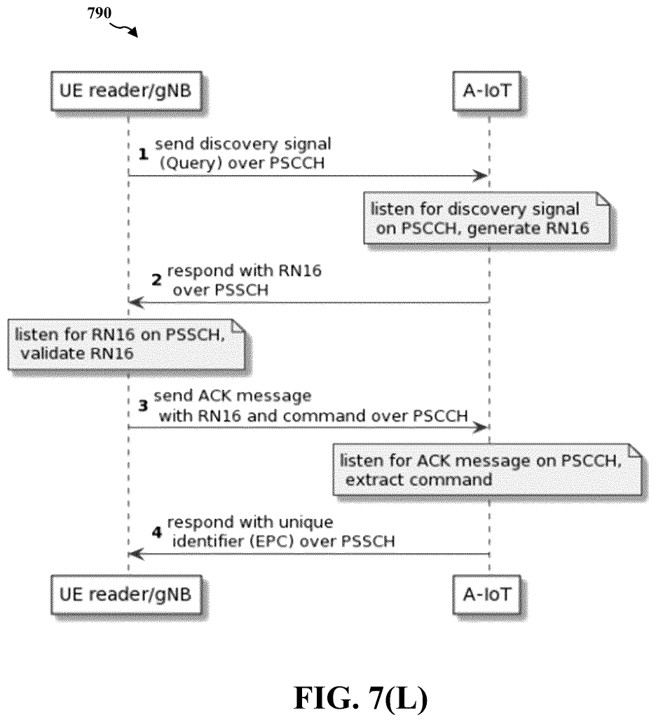

FIG. 7(A) is a diagram 700 illustrating an example wireless communication system including a base station and a UE. In this example, a UE 704 is connected to a base station 702 on a cell 706.

A-IoT devices often have limitations in terms of communication range, power consumption, and charging time. For instance, certain devices have a maximum coverage that is less than the maximum distance requirements for indoor use cases due to the activation power threshold. Increasing the transmit power can achieve the required range but may interfere with nearby base stations. Furthermore, the activation threshold of some devices depends on the rectifier's activation threshold in the RF energy harvester, leading to uncertainty for the base station to discover the device in a cell, especially when the device has low battery level or no battery.

The increasing use of IoT devices brings challenges in power management, with manual battery replacement or recharging being impractical due to cost, environmental, and safety factors. Existing technologies like barcodes and RFID also face limitations in reading range and interference. Therefore, there is a need for new IoT technologies that can support batteryless devices or those with energy storage that don't require manual intervention. The aim is to create a solution within 3GPP systems that can handle a high number of connections and device density, while reducing complexity and power consumption, thereby opening new markets and adding value across the value chain.

The present disclosure provides methods and systems for improving the communication range, power consumption, and charging time for A-IoT devices. The disclosure includes techniques for increasing the transmit power to achieve the required range while minimizing interference with nearby base stations. The disclosure also includes techniques for optimizing the activation threshold of devices based on the rectifier's activation threshold in the RF energy harvester, thereby reducing uncertainty for the base station to discover the device in a cell. Furthermore, the disclosure includes techniques for reducing the charging time for devices, particularly when using RF energy.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### System Topology

FIG. 7(B) is a diagram 710 illustrating an example communication link between a gNB and an A-IoT device though a connection with a UE via a wired cable. The present disclosure introduces a novel system topology for Ambient Internet of Things (A-IoT) communication. As shown in FIG. 7(B), the next-generation NodeB (gNB) establishes a connection with User Equipment (UE) or a UE reader via a wired cable. This configuration eliminates the need for a new air interface between the gNB and the A-IoT device, instead introducing a new air interface between the UE reader and the A-IoT device. As a result, the efforts required for any gNB specification change are significantly reduced. In this setup, the gNB can access the A-IoT device via the UE reader, which acts as an intermediate node between the device and the base station (gNB).

FIG. 7(C) is a diagram 720 illustrating an example communication link between a gNB and an A-IoT device though a connection with a UE via a wireless air interface. As shown in FIG. 7(C), a wireless air interface is established between the gNB and a UE or a UE reader. This air interface leverages the NR-Uu interface to minimize the specification change on the UE side. A new air interface between the UE and the A-IoT device is necessitated, the specifications of which can be determined based on the use cases and their corresponding requirements.

### Receiver Architectures

FIG. 7(D) is a diagram 730 illustrating a first type of an A-IoT device. Device A is designed with specific targets for power consumption during transmission/reception (≤1 μW or ≤10 μW), and complexity, which is aimed to be comparable to UHF RFID ISO18000-6C (EPC C1G2). Device A does not have energy storage or independent signal generation/amplification capabilities, and relies on backscattering transmission. It requires a backscattering activation power threshold, experiences reflection loss, and needs a distant carrier wave source to transmit signals for positioning.

The architecture of Device A includes the following components:
A low pass filter (LPF) for suppressing adjacent sub-carrier interference (ASCI) and adjacent carrier interference (ACI);
An envelope detector (ED) to support On-Off Keying (OOK)-based signals;
An analog to digital converter (ADC) for digital baseband processing;
A digital baseband (DBB) for sequence matching;
A modulator (switch) controlled by the incoming signal to add payload data for OOK modulation; and
A radio frequency energy harvester to convert RF signals into an energy source.

FIG. 7(E) is a diagram 732 illustrating a second type of an A-IoT device. Device B's design targets lie between those of Device A and Device C in terms of power and complexity. It has energy storage but no independent signal generation, relying on backscattering transmission. Stored energy can be used for signal amplification. Device B also requires a backscattering activation power threshold, experiences reflection loss, and needs a distant carrier wave source for positioning.

The architecture of Device B includes the following components:
An LPF for suppressing ASCI and ACI;
An ED to support OOK-based signals;
An ADC for digital baseband processing;
A DBB for sequence matching;
A modulator controlled by the incoming signal to add payload data for OOK modulation;
An RF energy harvester to convert RF signals into an energy source;
Additional energy harvesters for different types of ambient power sources, such as RF radio, solar energy, thermal energy, and piezoelectric power;
Energy storage, such as capacitors and solid-state batteries; and
A reflection amplifier to amplify the input signal to the tag and the backscattered signal towards the reader.

FIG. 7(F) is a diagram 734 illustrating a third type of an A-IoT device. Device C is designed with a power consumption target during transmission/reception of ≤1 mW to ≤10 mW, and a complexity target that is orders-of-magnitude lower than NarrowBand IoT (NB-IoT). Device C has energy storage, independent signal generation, and active RF components for transmission. It also has mobility management capabilities, at least for cell selection/re-selection.

The architecture of Device C includes the following components:
An LPF for suppressing ASCI and ACI;
An ED to support OOK-based signals;
An ADC for digital baseband processing;
A DBB for synchronization, payload decoding, and cyclic redundancy check (CRC) An RF energy harvester to convert RF signals into an energy source;
Additional energy harvesters for different types of ambient power sources, such as RF radio, solar energy, thermal energy, and piezoelectric power;
Energy storage, such as capacitors and solid-state batteries; and
A low-noise amplifier (LNA) and power amplifier (PA) to amplify reception and transmission signals.

### New Air Interface

FIG. 7(G) is a diagram 740 illustrating an example communication link between a UE such as the UE 744 and an A-IoT device such as the A-IoT device 746 via an air interface. The disclosure presents an innovative air interface for communication between User Equipment (UE) and the Ambient Internet of Things (A-IoT) device. The communication process is initiated when the UE powers up the A-IoT device and transmits a command. This command outlines essential communication parameters such as the tag rate, the tag data encoding method, and the total number of available time durations.

Once the A-IoT device has harvested enough energy, it gets activated and listens for the UE's command. After decoding the command, the A-IoT device randomly selects a time duration from the available range, and generates a random sequence. This sequence is then transmitted in the chosen time duration, preceded by a known preamble sequence.

In response to the A-IoT's transmission, the UE decodes the received preamble sequence and sends an acknowledgment back to the A-IoT within a predetermined duration, aligning with the system's configuration for the A-IoT rate.

FIG. 7(H) is a diagram 750 illustrating an example communication process between a reader device and an A-IoT device based on a chosen time duration. The User Equipment to Ambient IoT Device Communication Link (U2A Link) uses modulation schemes like Amplitude Shift Keying (ASK) or On-Off Keying (OOK) to facilitate Pulse Interval Encoding (PIE) for data transmission. The U2A link includes two preambles: a long U2A preamble for initial transmission and a short U2A preamble for subsequent signaling. The UE transmits the long U2A preamble and a control signal or command, specifying control parameters for the A-IoT device.

The Ambient IoT Device to User Equipment Communication Link (A2U Link) employs either ASK or Phase Shift Keying (PSK) modulation. The A-IoT encodes backscattered data using either FMO baseband or Miller modulation, as controlled by the UE or gNB via the A2U link. The A2U link signaling commences with one of two Miller Subcarrier Preambles, depending on the command or the control signal. The A-IoT employs backscatter modulation, altering its antenna's reflection coefficient to transmit data. The A2U link transmits Electronic Product Code (EPC) and Protocol-Control Information (PC).

### Modified 4-Step RACH

Considering that the A-IoT (Ambient IoT) device can only perform ASK (Amplitude Shift Keying) or OOK (On-Off Keying) modulation and backscattering communication, and that the Downlink (DL) signals can be PSS (Primary Synchronization Signal), SSS (Secondary Synchronization Signal), and OOK-based Low Power Wake-Up Signal (LP-WUS), the modified 4-step RACH procedure could be as follows:

1. DL Signal Reception: The A-IoT device listens for the PSS, SSS, or LP-WUS from the gNB or UE reader. These signals serve as an “inquiry command” for the A-IoT device. For example, the LP-WUS, specifically designed to wake up devices from a low-power state, could be particularly useful for A-IoT devices. Upon detecting one of these signals, the A-IoT device wakes up and prepares for further communication.

2. Preamble Transmission (Msg1): Upon receiving the DL signal, the A-IoT device generates a random 16-bit number (RN16) and sends it back to the gNB or UE reader. This is done through backscattering communication, using ASK or OOK modulation. This is similar to the RFID tag sending the RN16 to the reader in response to the inquiry command.

3. Random Access Response (Msg2): The gNB or UE reader sends an acknowledgment signal back to the A-IoT device, which includes the RN16. This acknowledgment could be sent on a specific DL channel that the A-IoT device is programmed to monitor. The A-IoT device, upon receiving this acknowledgment, knows that the gNB or UE reader has successfully received its RN16.

4. RRC Connection Request (Msg3): Once the A-IoT device receives the acknowledgment, it sends its Electronic Product Code (EPC) to the gNB or UE reader. This is done through backscattering communication, using ASK or OOK modulation. This EPC is a unique identifier for the A-IoT device, similar to the unique identifier of an RFID tag.

5. Contention Resolution (Msg4): The gNB or UE reader sends a contention resolution message to the A-IoT device, confirming the A-IoT device's EPC and completing the RACH procedure. This step ensures that the A-IoT device has been correctly identified and that there are no collisions with other A-IoT devices. The contention resolution message could include the EPC of the A-IoT device, so the device knows that the message is intended for it.

This modified 4-step RACH procedure aligns more closely with the RFID protocol, with the A-IoT device acting as the RFID tag and the gNB or UE reader acting as the RFID reader.

FIG. 7(I) is a sequence diagram 760 that describes the modified 4-step RACH procedure. In this diagram, the “A-IoT device” participant represents the A-IoT device, and the “gNB/UE reader” participant represents the gNB or UE reader. The arrows represent the communication between the two participants, and the notes provide additional information about the behavior of each participant at each step of the procedure.

### Modified 2-Step RACH

This subsection elucidates a proposed modification to the 2-step Random Access Channel (RACH) procedure, designed to accommodate the characteristics of Ambient Internet of Things (A-IoT) devices. The modification aligns with the RFID protocol and takes into account the A-IoT device's capabilities for Amplitude Shift Keying (ASK) or On-Off Keying (OOK) modulation and backscattering communication.

The procedure comprises two main stages:

1. Downlink Signal Transmission and Preamble Transmission (Msg1): The gNB or UE reader initiates the process by transmitting a Downlink (DL) signal, accompanied by a random 16-bit number (RN16), to the A-IoT device. The DL signal could be a Primary Synchronization Signal (PSS), Secondary Synchronization Signal (SSS), or Low Power Wake-Up Signal (LP-WUS), serving as an “inquiry command” for the A-IoT device. For instance, the gNB could dispatch a DL signal (PSS) along with an RN16 (1011 1100 0011 1110). The A-IoT device, upon receiving this signal, harnesses it to charge its battery.

2. Random Access Response and Contention Resolution (Msg2): In the subsequent stage, the A-IoT device validates the received RN16 against its tag ID. Upon a match, the A-IoT device reciprocates by transmitting the RN16 and its unique Electronic Product Code (EPC) to the gNB or UE reader, leveraging backscattering communication with ASK or OOK modulation. To illustrate, if the RN16 aligns with the tag ID of the A-IoT device, the device responds by backscattering the RN16 (1011 1100 0011 1110) and its EPC (e.g., 0000 1010 1111 0000). The gNB or UE reader, upon successful reception of the EPC, completes the RACH procedure by sending a final acknowledgment to the A-IoT device.

This modification to the 2-step RACH procedure brings it closer to the RFID protocol, casting the A-IoT device in the role of the RFID tag and the gNB or UE reader as the RFID reader. However, this is a simplified representation and may not encapsulate all facets of the NR and RFID protocols.

FIG. 7(J) is a sequence diagram 770 that describes a modified 2-step RACH procedure. In this sequence diagram, the “A-IoT device” participant stands for the A-IoT device, and the “gNB/UE reader” participant signifies the gNB or UE reader. The arrows denote the communication between the two participants, while the notes offer additional details about the behavior of each participant at each step of the procedure.

This diagrammatic representation aligns with the modified 2-step RACH procedure, which is designed to mimic the RFID protocol. The A-IoT device acts as the RFID tag and the gNB or UE reader plays the role of the RFID reader. It's important to note that this is a simplified model and might not encapsulate all aspects of the NR and RFID protocols. Real-world implementations could necessitate additional measures to manage errors, retransmissions, and security considerations. This sequence diagram serves as a high-level overview of the procedure, providing a foundation for further detailing based on specific implementation requirements.

### Modified RACH Procedure (UE Acting as a Tag Reader)

FIG. 7(K) is a sequence diagram 780 that describes a modified RACH procedure where a UE acts as a tag reader. As shown in FIG. 7(K), this modification allows a User Equipment (UE), acting as a reader, to communicate with Ambient Internet of Things (A-IoT) devices, acting as tags.

1. Preamble (Query): The UE (acting as the reader) initiates the process by sending a modified RACH preamble. This preamble is broadcast to all tags in its vicinity. This serves as the “Query” in the RFID protocol. The modified preamble could be sent over the Physical Random Access Channel (PRACH). The preamble could contain a specific sequence or pattern that the tags are programmed to recognize. For example, the preamble could start with a specific bit pattern followed by the UE's unique identifier.

The UE's behavior would involve generating the preamble and transmitting it over the PRACH. The UE would need to ensure that the preamble is detectable by the tags, which might require a change in the format or power level of the preamble.

2. Response (RN16): Upon detecting the preamble, each tag generates a random 16-bit number (RN16) and responds with it. This would be similar to the RACH Response in the current procedure. The tags would need to have the capability to generate and transmit this RN16, which is not a feature of traditional RFID tags. This would require modifications to the tag's firmware and possibly hardware. The response could be sent over the Physical Uplink Shared Channel (PUSCH).

The A-IoT device's behavior would involve listening for the preamble on the PRACH, generating the RN16 upon detecting the preamble, and transmitting the RN16 over the PUSCH.

3. Connection Setup (ACK): The UE listens for responses from the tags. Upon receiving a valid RN16 from a tag, the UE sends a modified Connection Setup message to that tag. This serves as the “ACK” in the RFID protocol. The UE would need to be modified to generate and send this ACK message. The ACK message could be sent over the Physical Downlink Control Channel (PDCCH) and could contain the RN16 and a command instructing the tag to transmit its unique identifier.

The UE's behavior would involve listening for the RN16 on the PUSCH, validating the RN16, and transmitting the ACK message over the PDCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PUSCH.

The A-IoT device's behavior would involve listening for the ACK message on the PDCCH, extracting the command from the ACK message, and transmitting its unique identifier over the PUSCH.

This would require significant changes to both the UE and the tags, including hardware and firmware modifications.

Absolutely, based on the context provided, FIG. 7(K) illustrates how a part of a technical report might look like with a PlantUML Sequence Diagram.

The proposed modification of the 5G NR RACH procedure allows a User Equipment (UE), acting as a reader, to communicate with Ambient Internet of Things (A-IoT) devices, acting as tags.

### Modified Sidelink Procedure

FIG. 7(L) is a sequence diagram 790 that describes a modified Sidelink procedure. This approach allows a User Equipment (UE), acting as an RFID reader, to interact with Ambient Internet of Things (A-IoT) devices, functioning as RFID tags.

1. Discovery Signal (Query): The UE (acting as the reader) sends a discovery signal to all tags in its vicinity. This serves as the “Query” in the RFID protocol. The discovery signal could be sent over the Physical Sidelink Control Channel (PSCCH). The signal could contain a specific sequence or pattern that the tags are programmed to recognize. For example, the signal could start with a specific bit pattern followed by the UE's unique identifier.

The UE's behavior would involve generating the discovery signal and transmitting it over the PSCCH. The UE would need to ensure that the signal is detectable by the tags, which might require a change in the format or power level of the signal.

2. Discovery Response (RN16): Upon detecting the discovery signal, each tag generates a random 16-bit number (RN16) and responds with it. This would be analogous to the Discovery Response in the current sidelink procedure. The tags would need to be modified to generate and transmit this RN16. The response could be sent over the Physical Sidelink Shared Channel (PSSCH).

The A-IoT device's behavior would involve listening for the discovery signal on the PSCCH, generating the RN16 upon detecting the signal, and transmitting the RN16 over the PSSCH.

3. Sidelink Connection Setup (ACK): The UE listens for responses from the tags. Upon receiving a valid RN16 from a tag, the UE sends a Sidelink Connection Setup message to that tag. This serves as the “ACK” in the RFID protocol. The UE would need to be modified to generate and send this ACK message. The ACK message could be sent over the PSCCH and could contain the RN16 and a command instructing the tag to transmit its unique identifier.

The UE's behavior would involve listening for the RN16 on the PSSCH, validating the RN16, and transmitting the ACK message over the PSCCH.

4. Data Transmission (EPC): Upon receipt of the ACK message, the tag responds with its unique identifier. This would be similar to the EPC in the RFID protocol. The tag would need to be modified to store its unique identifier and transmit it upon receipt of the ACK message. The unique identifier could be sent over the PSSCH.

The A-IoT device's behavior would involve listening for the ACK message on the PSCCH, extracting the command from the ACK message, and transmitting its unique identifier over the PSSCH.

This would require significant changes to both the UE and the tags, including hardware and firmware modifications.

FIG. 7(L) illustrates a part of a technical report with a PlantUML Sequence Diagram.

To harness the power of 5G New Radio (NR) for RFID-like communication, the present disclosure proposes a modified Sidelink procedure. This approach allows a User Equipment (UE), acting as an RFID reader, to interact with Ambient Internet of Things (A-IoT) devices, functioning as RFID tags.

### Charging Time

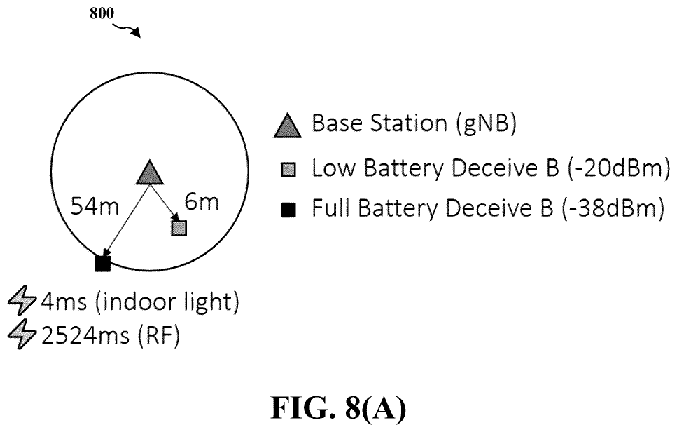

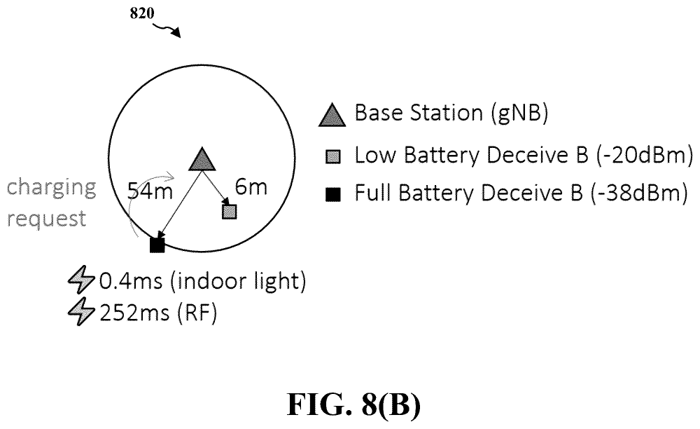

FIG. 8(A) is a diagram 800 illustrating an issue of charging time. In the deployment of Ambient Internet of Things (A-IoT) devices, one such device, Device B, uses a small capacitor or a battery to store harvested RF energy. This storage allows enough energy to accumulate for a report, with the activation threshold optimized to below −30 dBm. This threshold is dependent on the rectifier's activation threshold in the RF energy harvester.

However, an issue arises if Device B has an amplifier, which requires higher power consumption (˜100 uW or more). In such a case, RF signal energy harvesting may not be suitable due to its relatively low energy density. An alternative, such as energy storage with a solar panel, can be used.

Assuming Device B has no battery or a low battery level and is located 54m away from the base station (−38 dBm), using the RF energy harvester to support a Low Noise Amplifier (LNA) and 1 ms power-on time would require 2.5 seconds for charging. This charging time is significantly longer compared to the 4 ms required when using a 1 cm2 solar panel with indoor light.

Before Device B is fully charged for the 1 ms transmission, it is unreachable by the base station. This increases the uncertainty for the base station to discover Device B in a cell, presenting a significant concern for reliable communication.

By reducing the power-on time to 0.1 ms from 1 ms, the RF charging time drops from 2524 ms to 252 ms, a 90% decrease. This allows the tag to send a quick signal to the base station, indicating it needs more charging time for a complete payload transmission. However, this quick signal may not contain complete information, leading to potential communication issues.

The following table summarizes the charging times for different power-on times:

| | Charging | Charging |
|---|---|---|
| Power-On | Time by | Time |
| Time | Light | by RF |
| (ms) | (ms) | (ms) |
| 0.1 | 0.4 | 252 |
| 0.5 | 2 | 1262 |
| 1 (baseline) | 4 | 2524 |
| 5 | 20 | 12619 |
| 10 | 40 | 25238 |

These findings highlight the challenges in energy harvesting and charging time for A-IoT devices. The need for significant charging time, especially with RF energy harvesting, and the issue of device reachability during charging pose concerns for the practical deployment of such devices.

### Shortened Feedback Signals

FIG. 8(B) is a diagram 820 illustrating management of charging time using shortened feedback signals. The A-IoT device could employ a shortened feedback signal to relay its charging status to the gNB or UE reader. This approach is the most feasible as it requires minimal alterations to existing systems. This method allows the gNB or UE reader to promptly ascertain the charging status of the A-IoT device and adjust its communication schedule accordingly.

In this approach, the A-IoT device could generate a unique, shorter signal that represents its charging status. This signal could be a binary string of a specific length, with each bit or group of bits representing a different aspect of the charging status, such as the charging state, battery level, and estimated time to full charge.

For example, the charging status could be represented as a binary string of 8 bits, divided into different sections:

Charging State (2 bits): 00 for not charging, 01 for charging, and 10 for fully charged.

Battery Level (3 bits): A binary representation of the battery level divided into 8 levels, where 000 represents 0% (empty) and 111 represents 100% (full).

Time to Full Charge (3 bits): A binary representation of the estimated time to full charge divided into 8 levels, where 000 represents 0 minutes and 111 represents a maximum threshold, such as 120 minutes.

This shorter charging status message can be sent in response to a wake-up signal from the gNB or UE reader, indicating the device's readiness for further communication. The gNB or UE reader, upon receiving this message, can adjust its communication schedule accordingly. This approach allows for efficient communication while ensuring that the A-IoT device's energy status is accurately communicated.

The implementation of the shorter charging status message can be incorporated into the various procedures as follows:

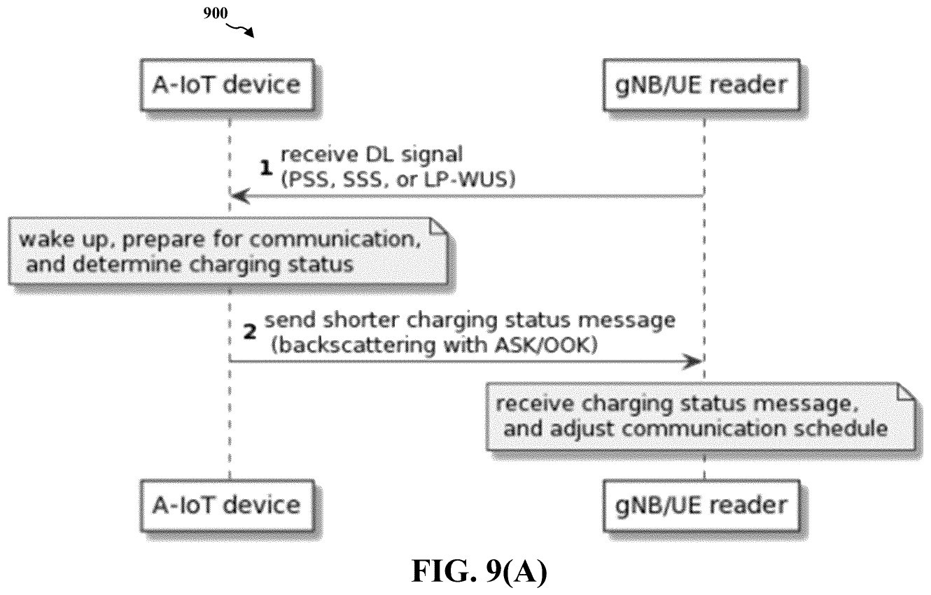

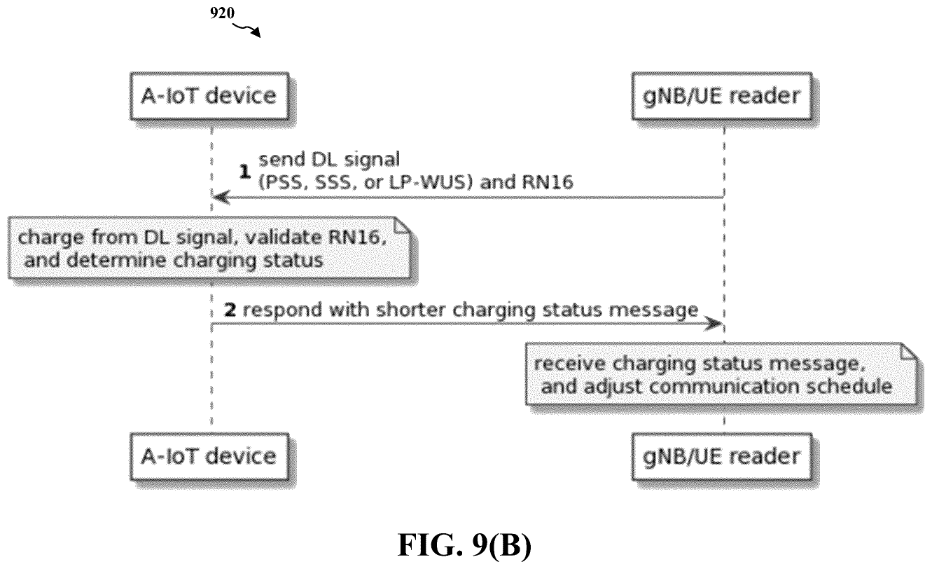

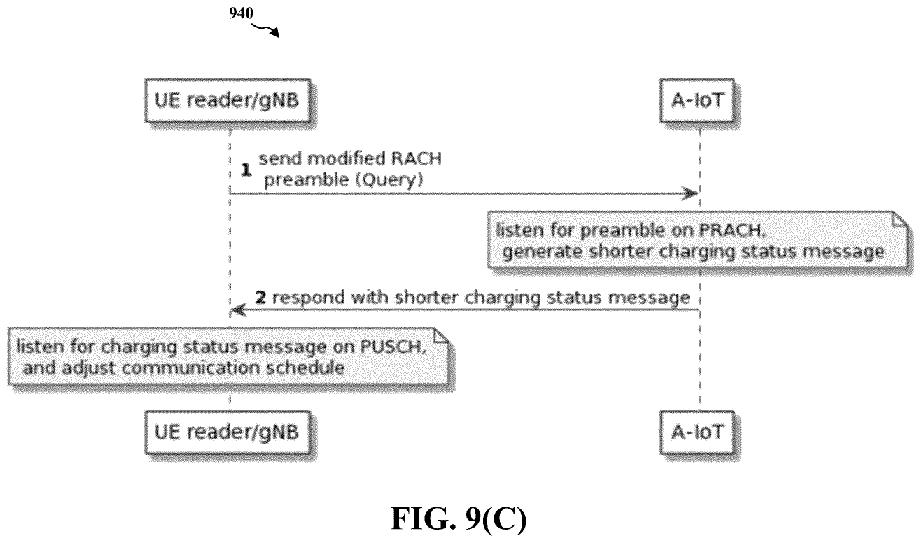

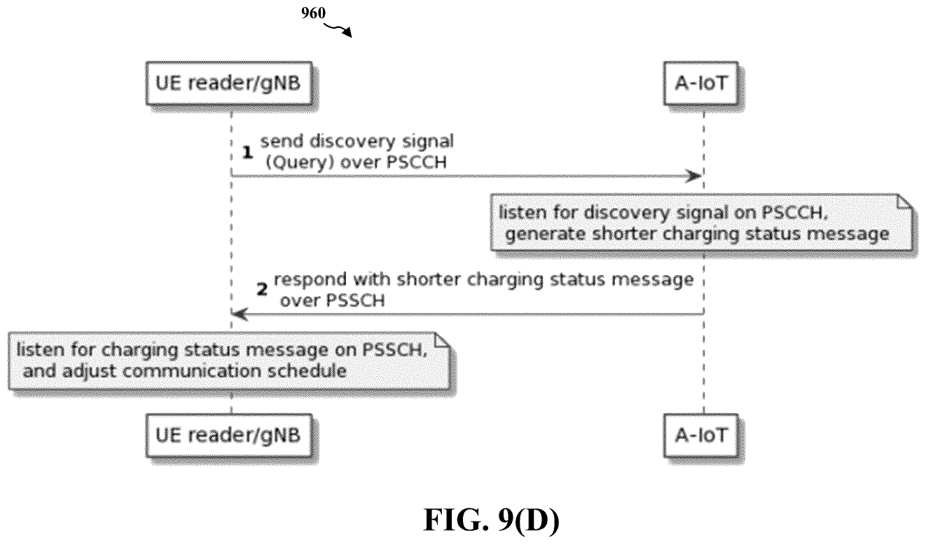

FIG. 9(A) is a sequence diagram 900 that describes a modified 4-step RACH procedure regarding shortened feedback signals. In the modified 4-step RACH procedure, the A-IoT device could send the shorter charging status message instead of the RN16 after receiving the Downlink (DL) signal from the gNB or UE reader.

FIG. 9(B) is a sequence diagram 920 that describes a modified 2-step RACH procedure regarding shortened feedback signals. In the modified 2-step RACH procedure, the A-IoT device could send the shorter charging status message in response to the DL signal.

FIG. 9(C) is a sequence diagram 940 that describes a modified RACH procedure where a UE acts as a tag reader regarding shortened feedback signals. In the modified RACH procedure where the UE acts as a tag reader, the A-IoT device could send the shorter charging status message in response to the preamble from the UE reader.

FIG. 9(D) is a sequence diagram 960 that describes a modified Sidelink procedure regarding shortened feedback signals. In the modified Sidelink procedure, the A-IoT device could send the shorter charging status message in response to the discovery signal from the UE reader.

In all these procedures, the gNB or UE reader would need to be modified to extract the charging status from the shorter charging status message and adjust its communication schedule accordingly.

The conditions under which the A-IoT device chooses to send the shorter charging status message or the RN16 are for efficient communication. These conditions can vary based on the specific implementation of the communication protocol and the characteristics of the A-IoT device itself.

### Sending Shorter Charging Status Message

The A-IoT device sends the shorter charging status message under the following conditions:

1. Low Energy Level: The device sends the shorter charging status message when its energy level is too low for backscattering communication, thereby informing the gNB or UE reader that it needs more time to charge.

2. Charging State Change: If there is a change in the device's charging state, such as when it starts charging or when it's fully charged, the device sends the shorter charging status message to inform the gNB or UE reader of the change.

### Sending RN16

The A-IoT device sends the RN16 under the following conditions:

1. Sufficient Energy Level: If the device's energy level is sufficient for backscattering communication, it sends the RN16 as part of the normal communication process.

2. No Change in Charging State: If there is no change in the device's charging state, and it's not currently charging or it's fully charged, the device sends the RN16.

These conditions ensure that the A-IoT device communicates its energy state efficiently, allowing the gNB or UE reader to adjust its communication schedule accordingly. However, these are generalized conditions, and the exact conditions can vary based on the specific implementation of the communication protocol and the characteristics of the A-IoT device.

### Charging Status in RN16

Incorporating the charging status in the RN16 signal that the A-IoT device sends to the gNB or UE reader is another feasible solution. However, this approach requires modifications to the A-IoT device's signal generation. It enables the gNB or UE reader to receive the charging status of the A-IoT device early in the communication process.

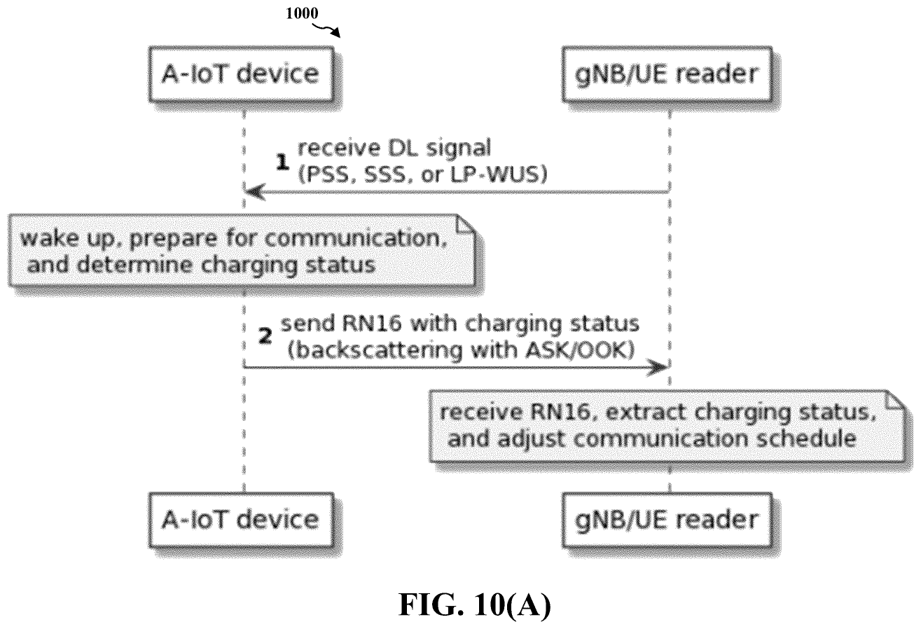

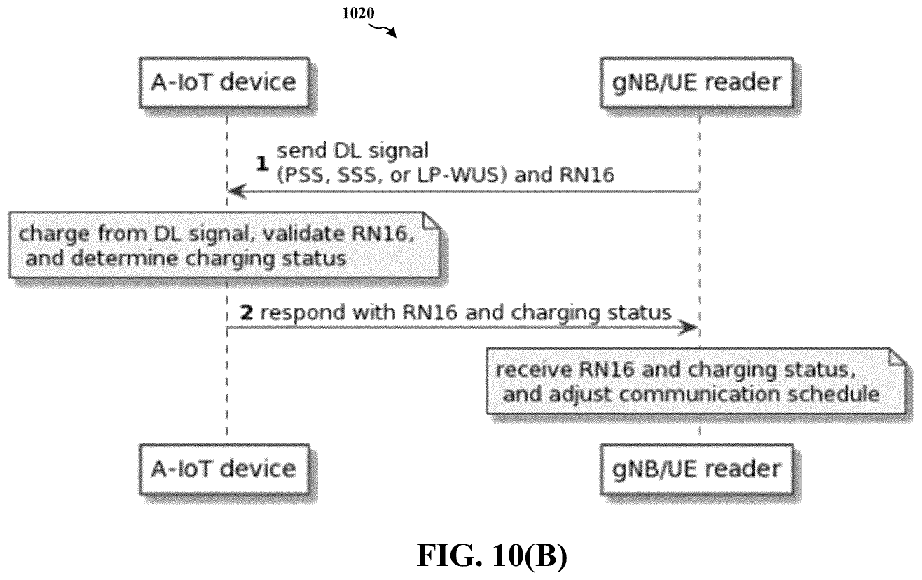

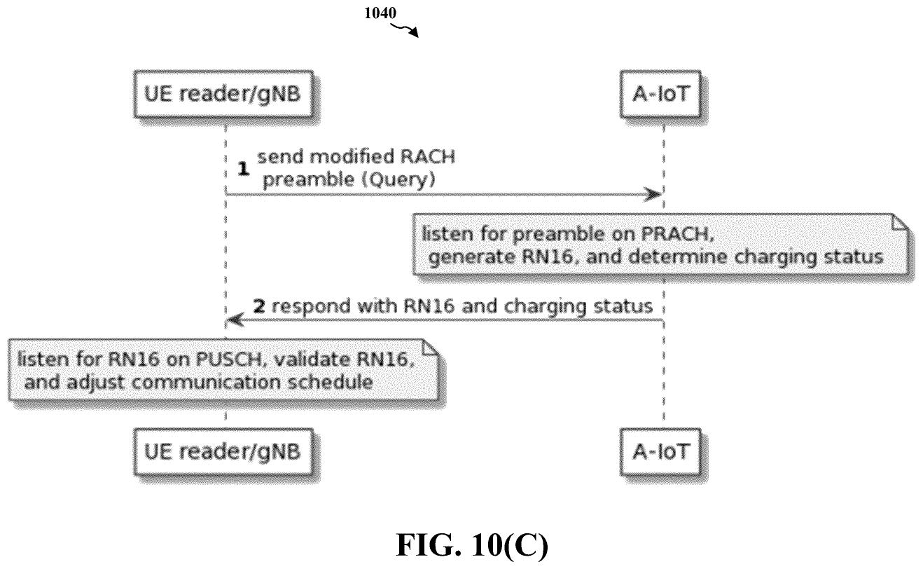

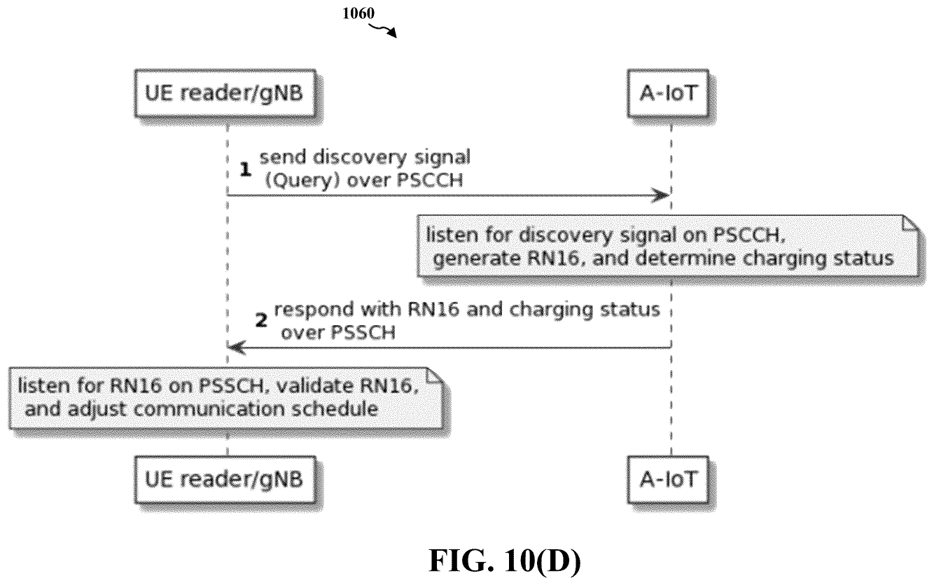

FIG. 10(A) is a sequence diagram 1000 that describes a modified 4-step RACH procedure regarding a charging status in RN16. In the modified 4-step RACH procedure, the A-IoT device could use a portion of the RN16 signal to indicate its charging status. For example, the first few bits of the RN16 could be used to represent different charging statuses. This would require a change in the A-IoT device's signal generation to include the charging status in the RN16.

FIG. 10(B) is a sequence diagram 1020 that describes a modified 2-step RACH procedure regarding a charging status in RN16. In the modified 2-step RACH procedure, the A-IoT device could include its charging status in the RN16 that it sends in response to the DL signal. This would require a change in the A-IoT device's signal generation to include the charging status in the RN16.

FIG. 10(C) is a sequence diagram 1040 that describes a modified RACH procedure where a UE acts as a tag reader regarding a charging status in RN16. In the modified RACH procedure where the UE acts as a tag reader, the A-IoT device could include its charging status in the RN16 that it sends in response to the preamble. This would require a change in the A-IoT device's signal generation to include the charging status in the RN16.

FIG. 10(D) is a sequence diagram 1060 that describes a modified Sidelink procedure regarding a charging status in RN16. In the modified Sidelink procedure, the A-IoT device could include its charging status in the discovery response that it sends in response to the discovery signal. This would require a change in the A-IoT device's signal generation to include the charging status in the discovery response.

In all these procedures, the gNB or UE reader would need to be modified to extract the charging status from the RN16 or discovery response and adjust its communication schedule accordingly.

The A-IoT device will send its charging status based on the following conditions:

Wake-up Signal Received: The device sends its charging status in response to a wake-up signal from the gNB or UE reader. This signal prompts the device to wake up from a low-power state and prepare for communication.

Insufficient Energy for Communication: If the device's energy level is too low for backscattering communication, it sends its charging status to inform the gNB or UE reader that it needs more time to charge.

Charging Status Changed: If there is a change in its charging status, such as when it starts charging or when it's fully charged, the device sends its charging status to inform the gNB or UE reader of the change.

### If A-IoT Sends Charging Status:

Early Termination of Protocol: Sending the charging status acts as an early termination of the protocol. The A-IoT device signals to the gNB that it needs more time to charge. It doesn't proceed further with the protocol, such as sending its Electronic Product Code (EPC).

Continue Charging: After sending its charging status, the A-IoT device continues to harvest energy and charge its battery until it reaches a sufficient charge level.

### If A-IoT Doesn't Send Charging Status:

Complete Protocol: If the A-IoT device doesn't send its charging status, it indicates that it has enough charge to communicate. It continues with the protocol, including waiting for an acknowledgment (ACK) from the gNB.

Send EPC: Upon receiving the ACK, the A-IoT device sends its EPC to the gNB.

Prepare for Further Communication: After sending the EPC, the A-IoT device prepares for further communication, such as data exchange, with the gNB.

The charging status typically encapsulates the following information:

Charging State: This indicates whether the device is currently charging, fully charged, or not charging.

Battery Level: This represents the current level of the device's battery or energy storage.

Time to Full Charge: If the device is currently charging, this provides an estimate of how much longer it will take to reach a full charge.

To provide a concrete example, the charging status could be represented as a binary string divided into different sections. Each section represents a different aspect of the charging status:

Charging State (2 bits): 00 for not charging, 01 for charging, and 10 for fully charged.

Battery Level (6 bits): A binary representation of the battery level as a percentage, where 000000 represents 0% and 111111 represents 100%.

Time to Full Charge (8 bits): A binary representation of the estimated time to full charge in minutes, where 00000000 represents 0 minutes and 11111111 represents 255 minutes.

A typical charging status might look like this: 0110010110101110. Here, 01 indicates that the device is charging, 100101 represents a battery level of 37%, and 10101110 represents an estimated time to full charge of 174 minutes.

Upon receiving the charging status, the gNB or UE reader might undertake the following actions:

Adjust Communication Schedule: Based on the received charging status, the gNB or UE reader can adjust its communication schedule. For instance, if the charging status indicates that the A-IoT device will need 30 more minutes to fully charge, the gNB can reschedule further communication with this device to after 30 minutes, thereby increasing the efficiency of the communication process.

Acknowledge Receipt: The gNB or UE reader could send an acknowledgment signal back to the A-IoT device to confirm receipt of the charging status and, if applicable, to initiate further communication.

Monitor A-IoT Device: The gNB or UE reader might continue to monitor the A-IoT device's signals if the charging status indicates that the device is still charging. This allows the gNB to be ready to communicate as soon as the device is fully charged.

Proceed with Other Tasks: If the charging status indicates that the A-IoT device needs more time to charge, the gNB or UE reader might switch to other tasks, such as communicating with other A-IoT devices that are ready for communication or processing received data.

These examples illustrate how the gNB or UE reader can adapt its behavior based on the charging status received from an A-IoT device. However, the exact reactions would depend on the specific implementation of the communication protocol and the characteristics of the gNB or UE reader.

### Scheduled Inquiry Commands

The gNB or UE reader can schedule its inquiry commands based on the known charging times of the A-IoT devices. This solution is feasible but necessitates effective communication schedule management by the gNB or UE reader. It minimizes the likelihood of the gNB or UE reader attempting to communicate with an A-IoT device that is still charging.

### Example 1: Scheduling Based on Charging Times

Suppose the gNB has a list of A-IoT devices with their respective power-on times and charging times. For instance, A-IoT device 1 has a power-on time of 0.5 ms and takes 1262 ms to charge by RF, while A-IoT device 2 has a power-on time of 5 ms and takes 12619 ms to charge by RF. The gNB can schedule its inquiry commands such that it communicates with device 1 after 1262 ms and with device 2 after 12619 ms. This ensures that communication attempts align with the devices' readiness, thereby enhancing the efficiency of the communication process.

### Example 2: Adjusting Schedule Based on Charging Status

In another scenario, the gNB receives a shorter charging status message from an A-IoT device indicating that it will take 25238 ms to fully charge (assuming the device has a power-on time of 10 ms and is charging by RF). The gNB can adjust its communication schedule and postpone the next inquiry command to this device by 25238 ms. This allows the device enough time to charge while ensuring that the gNB doesn't attempt to communicate with a device that is still charging.

These examples illustrate how the gNB or UE reader can adapt its communication schedule based on the known charging times of the A-IoT devices. The exact schedule would depend on the specific implementation of the communication protocol and the characteristics of the A-IoT devices.

Implementing scheduled inquiry commands based on known charging times can be incorporated into the modified procedures as follows:

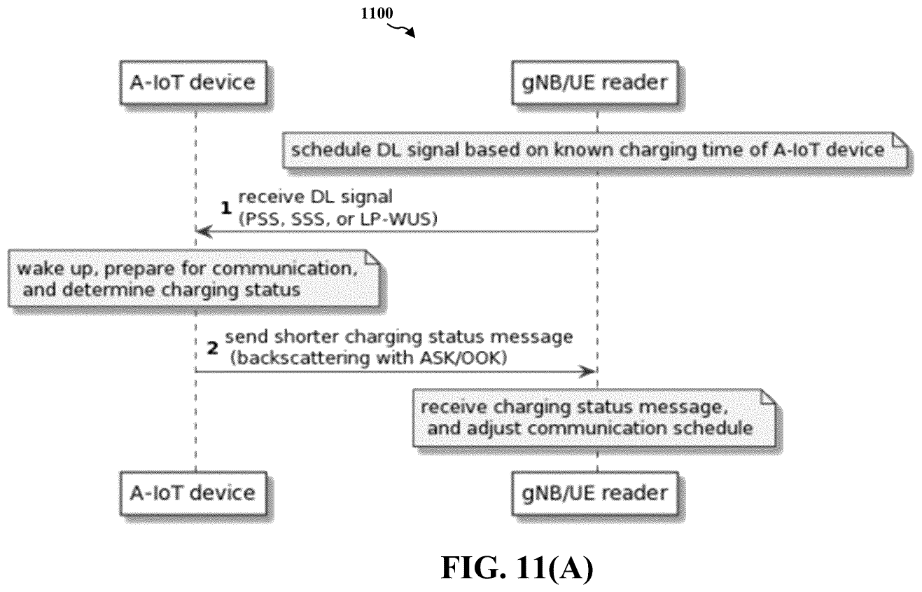

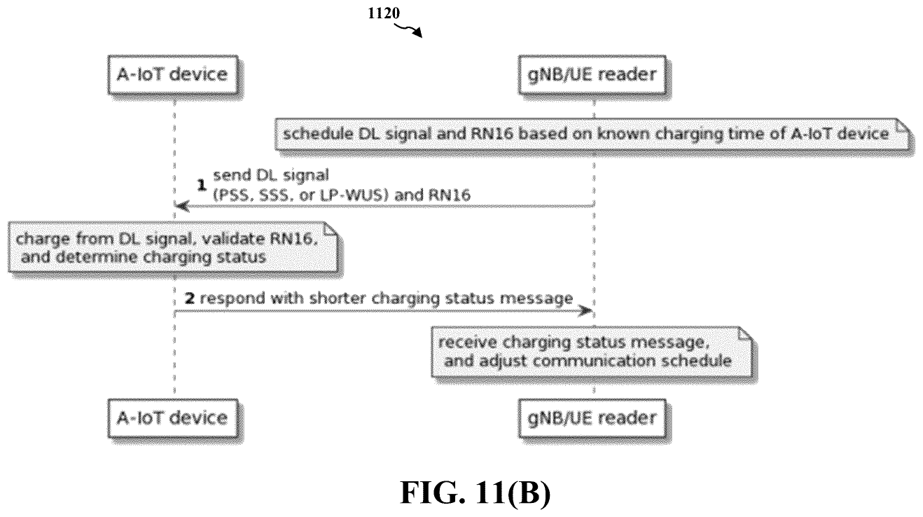

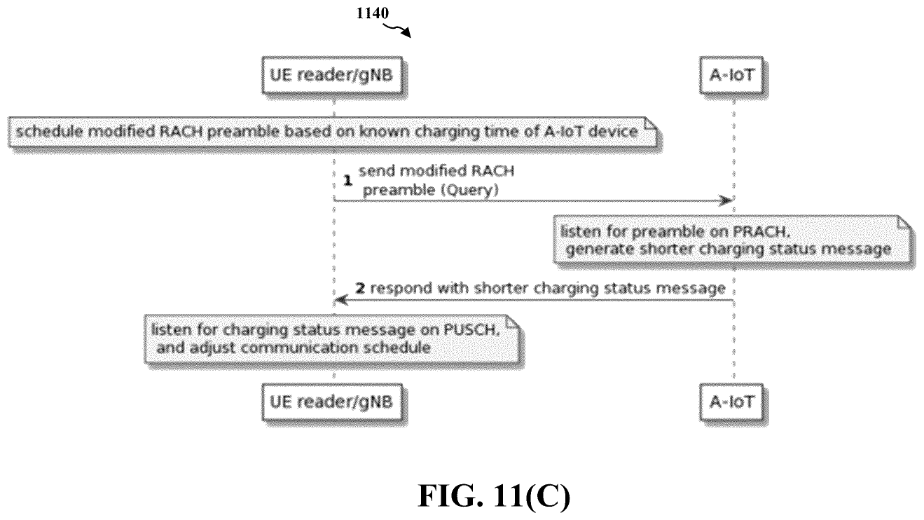

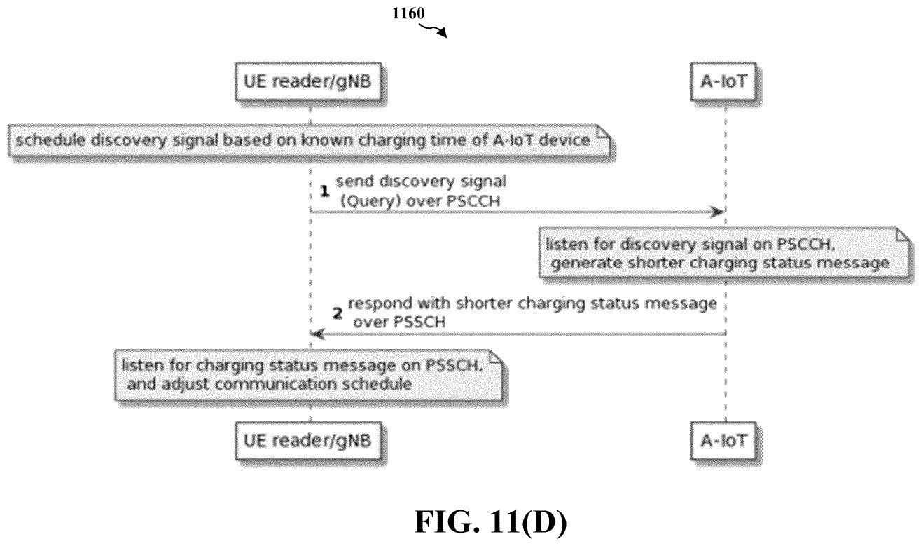

FIG. 11(A) is a sequence diagram 1100 that describes a modified 4-step RACH procedure regarding scheduled inquiry commands. In the modified 4-step RACH procedure, the gNB or UE reader could schedule its DL signal based on the known charging times of the A-IoT devices.

FIG. 11(B) is a sequence diagram 1120 that describes a modified 2-step RACH procedure regarding scheduled inquiry commands. In the modified 2-step RACH procedure, the gNB or UE reader could schedule its DL signal and RN16 based on the known charging times of the A-IoT devices.

FIG. 11(C) is a sequence diagram 1140 that describes a modified RACH procedure where a UE acts as a tag reader regarding scheduled inquiry commands. In the modified RACH procedure where the UE acts as a tag reader, the UE reader could schedule its preamble based on the known charging times of the A-IoT devices.

FIG. 11(D) is a sequence diagram 1160 that describes a modified Sidelink procedure regarding scheduled inquiry commands. In the modified Sidelink procedure, the UE reader could schedule its discovery signal based on the known charging times of the A-IoT devices.

In all these procedures, the gNB or UE reader would need to be modified to extract the charging status from the shorter charging status message and adjust its communication schedule accordingly. The gNB or UE reader must also manage its communication schedule based on the known charging times of the A-IoT devices.

### Adaptive ACK Timing

The gNB or UE reader could adjust the timing of its ACK signal based on the charging status of the A-IoT device. This solution is feasible but requires the gNB or UE reader to have the ability to adjust its signal timing. It enables the gNB or UE reader to postpone further communication with an A-IoT device that needs more charging time.

### Example 1: Adjusting ACK Timing Based on Charging Status

Consider an A-IoT device that is currently charging and sends a shorter charging status message to the gNB, indicating that it will take 1262 ms (corresponding to a device with a power-on time of 0.5 ms charging by RF) to fully charge. The gNB, upon receiving this message, can adjust the timing of its ACK signal to be sent after 1262 ms. This ensures that the ACK signal is sent when the device is ready for further communication, thereby enhancing the efficiency of the communication process.

### Example 2: Postponing Communication Based on Charging Status

In another scenario, the gNB receives a shorter charging status message from an A-IoT device indicating that it will take 25238 ms (corresponding to a device with a power-on time of 10 ms charging by RF) to fully charge. The gNB can postpone the next ACK signal to this device by 25238 ms. This allows the device enough time to charge while ensuring that the gNB does not attempt to communicate with a device that is still charging.

These examples illustrate how the gNB or UE reader can adapt the timing of its ACK signal based on the charging status of the A-IoT devices. The exact timing would depend on the specific implementation of the communication protocol and the characteristics of the A-IoT devices. However, the successful implementation of this strategy requires the gNB or UE reader to have the ability to adjust its signal timing dynamically.

Implementing adaptive ACK timing based on the charging status can be incorporated into the modified procedures as follows:

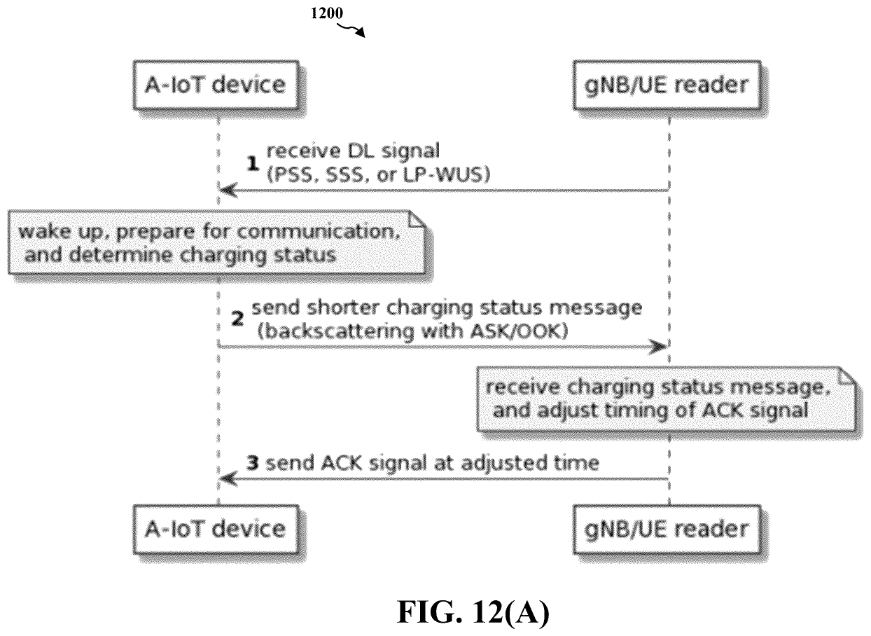

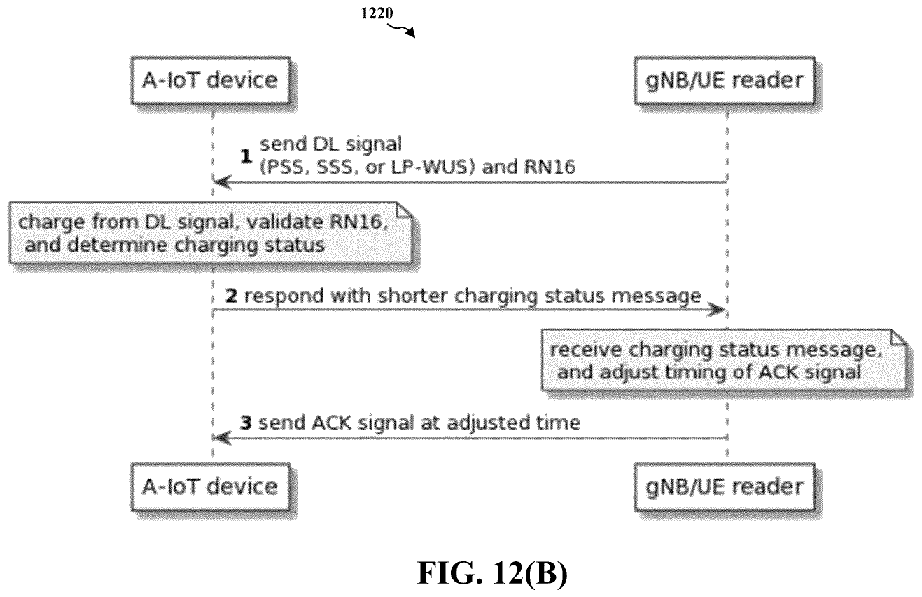

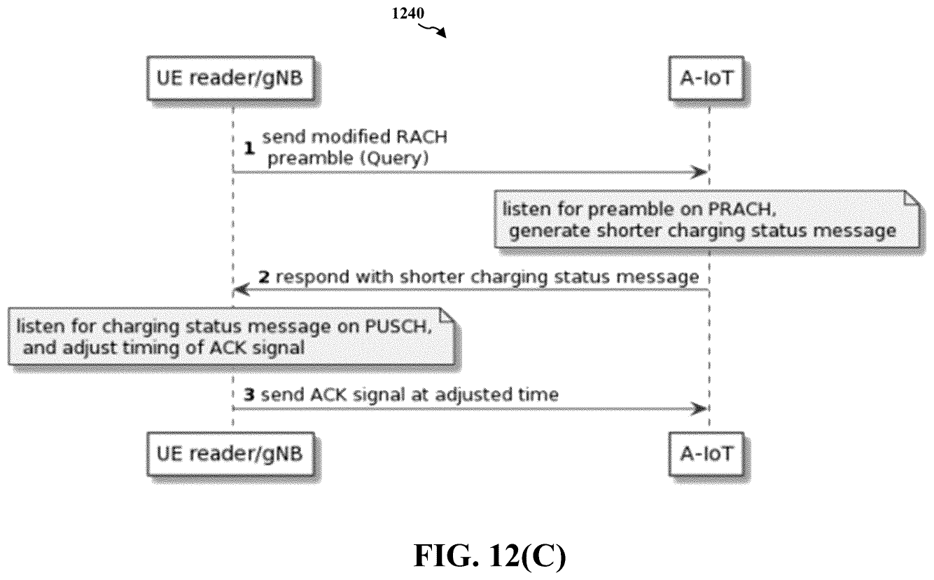

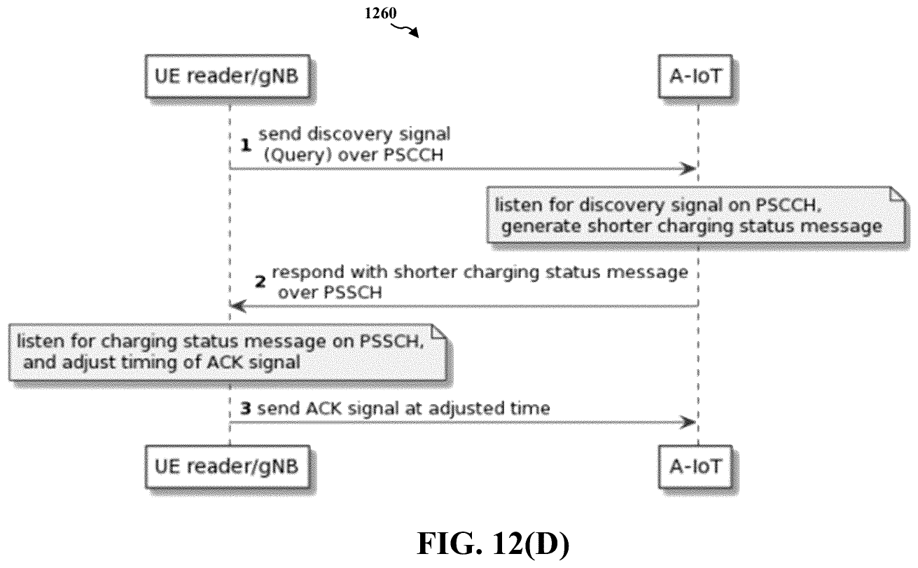

FIG. 12(A) is a sequence diagram 1200 that describes a modified 4-step RACH procedure regarding adaptive ACK timing. In the modified 4-step RACH procedure, the gNB or UE reader could adjust the timing of its ACK signal based on the charging status received from the A-IoT device.

FIG. 12(B) is a sequence diagram 1220 that describes a modified 2-step RACH procedure regarding adaptive ACK timing. In the modified 2-step RACH procedure, the gNB or UE reader could adjust the timing of its ACK signal based on the charging status received from the A-IoT device.

FIG. 12(C) is a sequence diagram 1240 that describes a modified RACH procedure where a UE acts as a tag reader regarding adaptive ACK timing. In the modified RACH procedure where the UE acts as a tag reader, the UE reader could adjust the timing of its ACK signal based on the charging status received from the A-IoT device.

FIG. 12(D) is a sequence diagram 1260 that describes a modified Sidelink procedure regarding adaptive ACK timing. In the modified Sidelink procedure, the UE reader could adjust the timing of its ACK signal based on the charging status received from the A-IoT device.

In all these procedures, the gNB or UE reader would need to be modified to extract the charging status from the shorter charging status message and adjust the timing of its ACK signal accordingly. The gNB or UE reader must also manage its communication schedule based on the charging status of the A-IoT devices.

### Charging Status in EPC

The A-IoT device could include its charging status in the EPC signal it sends to the gNB or UE reader. This solution is moderately feasible, requiring changes to the A-IoT device's signal generation. It allows the gNB or UE reader to know the charging status of the A-IoT device as soon as it receives the EPC.

Incorporating the charging status of the A-IoT device into the EPC (Electronic Product Code) signal it sends to the gNB or UE reader presents another feasible solution. This strategy, while moderately feasible, necessitates changes to the A-IoT device's signal generation process. It enables the gNB or UE reader to understand the charging status of the A-IoT device as soon as it receives the EPC.

### Example 1: Charging Status in EPC Signal

Consider an A-IoT device that is currently charging and has to send an EPC signal to the gNB. The device includes its charging status in the EPC signal, indicating that it will take 1262 ms (corresponding to a device with a power-on time of 0.5 ms charging by RF) to fully charge. The gNB, upon receiving this EPC signal, can understand the device's charging status and adjust its communication schedule accordingly.

### Example 2: Adjusting Communication Based on EPC Signal

In another scenario, the gNB receives an EPC signal from an A-IoT device, which includes the charging status indicating that it will take 25238 ms (corresponding to a device with a power-on time of 10 ms charging by RF) to fully charge. The gNB can postpone the next communication with this device by 25238 ms. This allows the device enough time to charge while ensuring that the gNB does not attempt to communicate with a device that is still charging.

These examples illustrate how the inclusion of the charging status in the EPC signal can allow the gNB or UE reader to adjust its communication schedule based on the charging status of the A-IoT devices. The exact implementation would depend on the specific changes made to the A-IoT device's signal generation process.

Implementing the inclusion of charging status in the EPC signal can be incorporated into the modified procedures as follows:

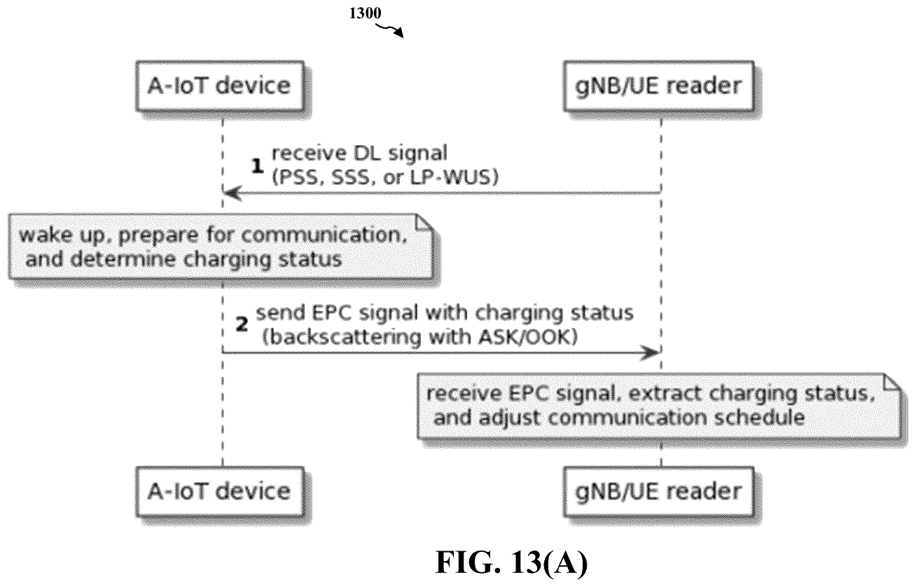

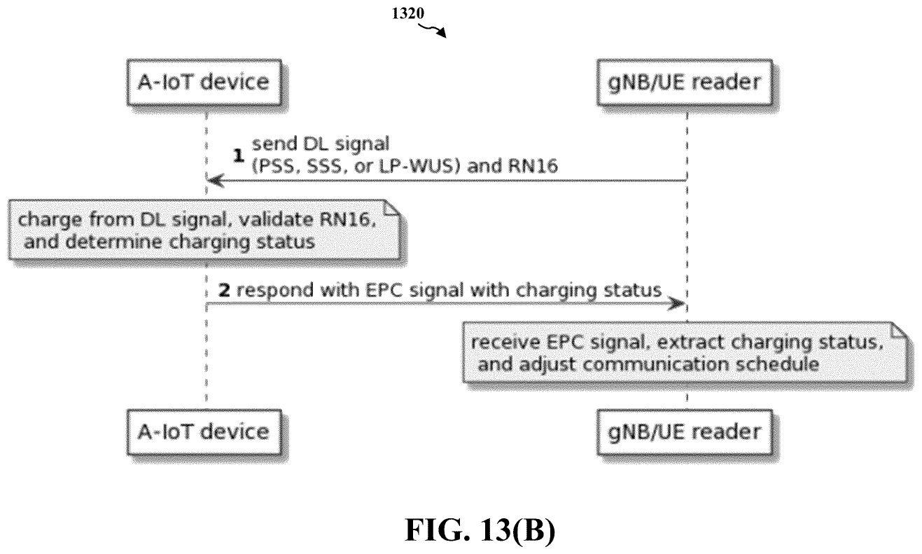

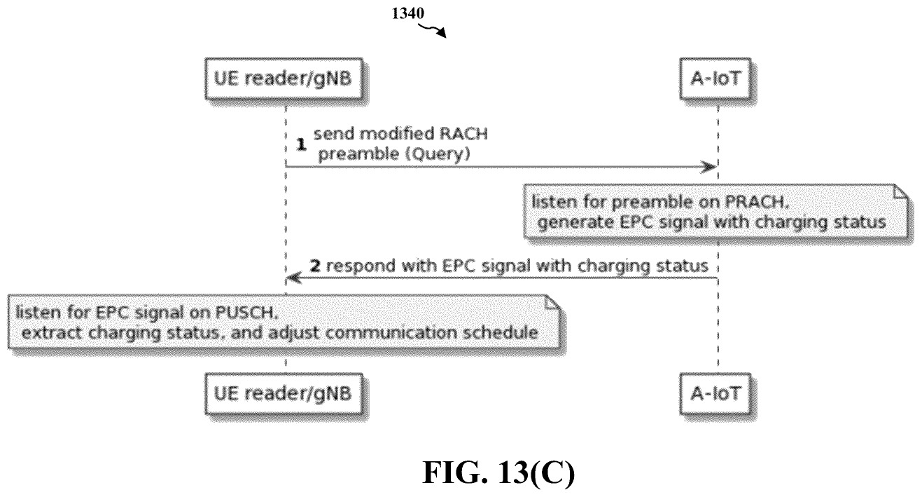

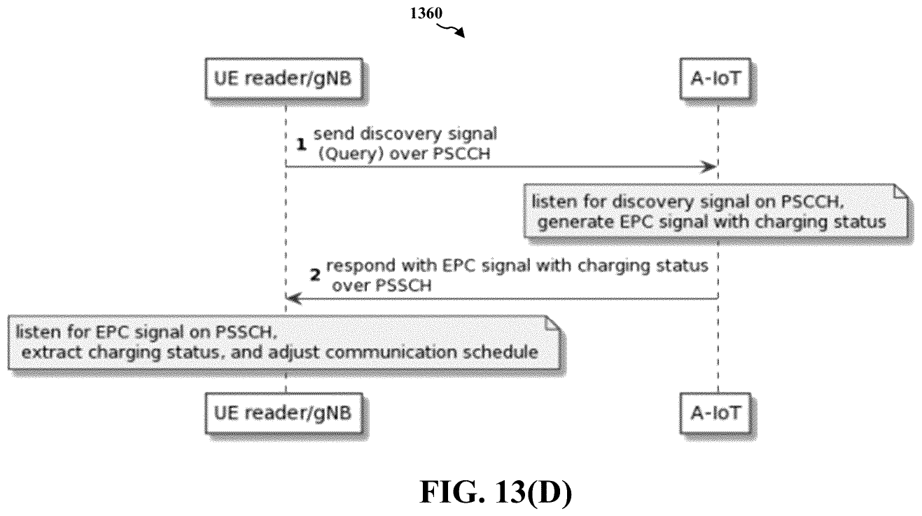

FIG. 13(A) is a sequence diagram 1300 that describes a modified 4-step RACH procedure regarding a charging status in EPC. In the modified 4-step RACH procedure, the A-IoT device could include its charging status in the EPC signal it sends in response to the DL signal from the gNB or UE reader.

FIG. 13(B) is a sequence diagram 1320 that describes a modified 2-step RACH procedure regarding a charging status in EPC. In the modified 2-step RACH procedure, the A-IoT device could include its charging status in the EPC signal it sends in response to the DL signal and RN16 from the gNB or UE reader.

FIG. 13(C) is a sequence diagram 1340 that describes a modified RACH procedure where a UE acts as a tag reader regarding a charging status in EPC. In the modified RACH procedure where the UE acts as a tag reader, the A-IoT device could include its charging status in the EPC signal it sends in response to the preamble from the UE reader.

FIG. 13(D) is a sequence diagram 1360 that describes a modified Sidelink procedure regarding a charging status in EPC. In the modified Sidelink procedure, the A-IoT device could include its charging status in the EPC signal it sends in response to the discovery signal from the UE reader.

In all these procedures, the gNB or UE reader would need to be modified to extract the charging status from the EPC signal and adjust its communication schedule accordingly. The A-IoT device must also be modified to include its charging status in the EPC signal it sends.

### Multiple RN16 Signals

If the A-IoT device requires more charging time, it could send multiple RN16 signals in quick succession. This solution is moderately feasible but could lead to signal collision if not managed properly. It provides a clear indication to the gNB or UE reader that the A-IoT device needs more charging time.

### Example 1: Sending Multiple RN16 Signals

Consider an A-IoT device that is currently charging and needs more time to fully charge. Instead of sending a single RN16 signal, the device sends multiple RN16 signals in quick succession. The gNB, upon receiving these signals, can understand that the device needs more charging time. Consequently, the gNB can adjust its communication schedule to allow the device more time to charge.

Suppose this device has a power-on time of 0.5 ms, and thus, based on the table provided earlier, it requires 1262 ms to charge by RF. To indicate this, the device sends multiple RN16 signals in quick succession. The gNB, upon receiving these signals, understands that the device needs approximately 1262 ms more to charge. Consequently, the gNB can adjust its communication schedule to allow the device this additional time to charge.

### Example 2: Managing Signal Collision

In another scenario, multiple A-IoT devices in the network are low on charge and send multiple RN16 signals in quick succession. The gNB or UE reader must manage these signals carefully to avoid signal collision. This could be achieved by implementing a collision avoidance strategy, such as random backoff, where each A-IoT device waits for a random amount of time before retransmitting its RN16 signal.

Suppose one device with a power-on time of 5 ms requires 12619 ms to charge by RF, and another device with a power-on time of 10 ms requires 25238 ms to charge by RF. Both devices send multiple RN16 signals in quick succession to indicate their charging times. The gNB or UE reader must manage these signals carefully to avoid signal collision. This could be achieved by implementing a collision avoidance strategy, such as random backoff, where each A-IoT device waits for a random amount of time before retransmitting its RN16 signal.

These examples illustrate how the A-IoT devices can use multiple RN16 signals to indicate the need for more charging time. The exact implementation would depend on the specific characteristics of the A-IoT devices and the strategies implemented by the gNB or UE reader to manage potential signal collisions.

Implementing the transmission of multiple RN16 signals for indicating extended charging time can be incorporated into the modified procedures as follows:

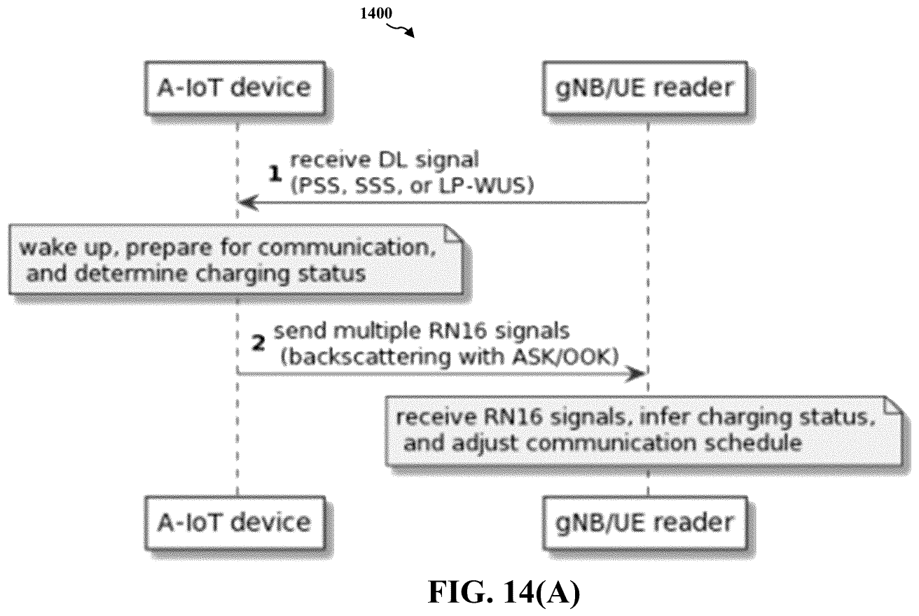

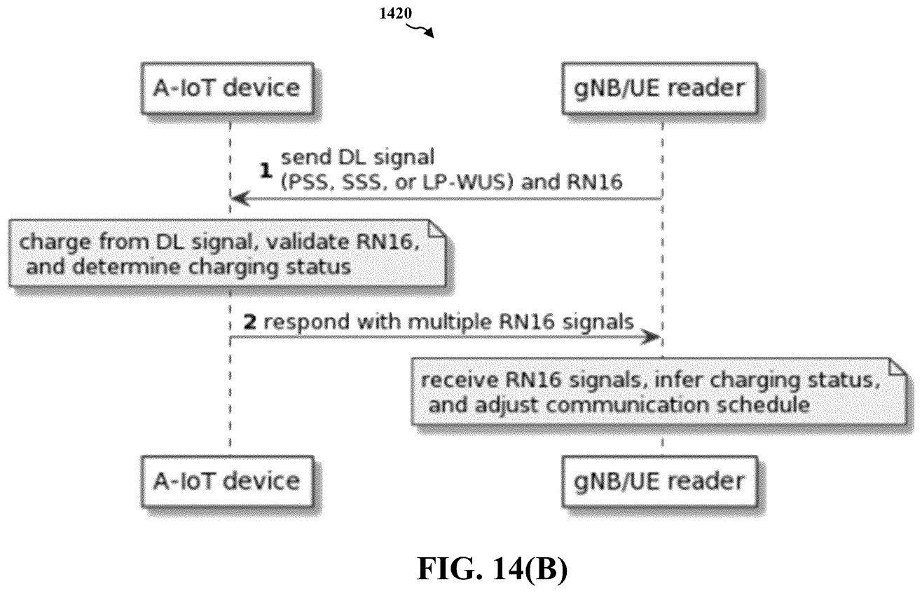

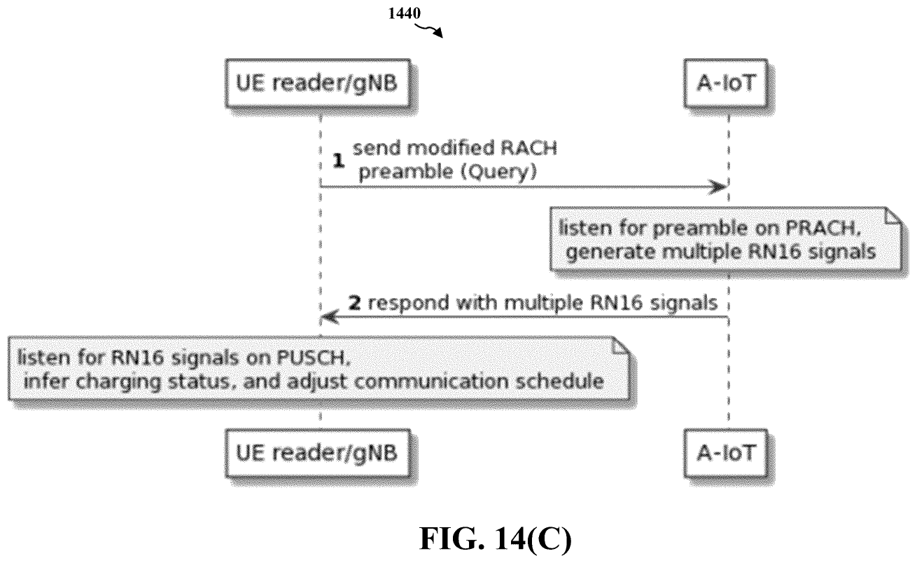

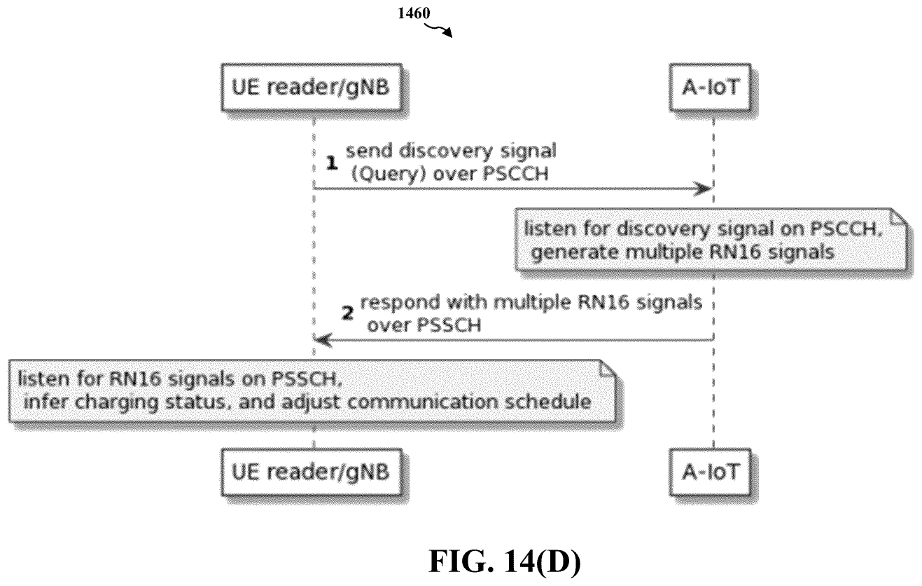

FIG. 14(A) is a sequence diagram 1400 that describes a modified 4-step RACH procedure regarding multiple RN16 signals. In the modified 4-step RACH procedure, the A-IoT device could send multiple RN16 signals in quick succession in response to the DL signal from the gNB or UE reader.

FIG. 14(B) is a sequence diagram 1420 that describes a modified 2-step RACH procedure regarding multiple RN16 signals. In the modified 2-step RACH procedure, the A-IoT device could send multiple RN16 signals in quick succession in response to the DL signal and RN16 from the gNB or UE reader.

FIG. 14(C) is a sequence diagram 1440 that describes a modified RACH procedure where a UE acts as a tag reader regarding multiple RN16 signals. In the modified RACH procedure where the UE acts as a tag reader, the A-IoT device could send multiple RN16 signals in quick succession in response to the preamble from the UE reader.

FIG. 14(D) is a sequence diagram 1460 that describes a modified Sidelink procedure regarding multiple RN16 signals. In the modified Sidelink procedure, the A-IoT device could send multiple RN16 signals in quick succession in response to the discovery signal from the UE reader.

In all these procedures, the gNB or UE reader would need to be modified to infer the charging status from the multiple RN16 signals and adjust its communication schedule accordingly. The A-IoT device must also be modified to send multiple RN16 signals when it requires more charging time.

### Charging Status Backscatter

The A-IoT device could backscatter a specific signal pattern to the gNB or UE reader to indicate its charging status. This solution is moderately feasible but requires changes to the A-IoT device's backscattering capabilities. It provides a direct way for the A-IoT device to communicate its charging status to the gNB or UE reader.

### Example 1: Backscattering Charging Status

Consider an A-IoT device that is currently charging and needs to communicate its charging status to the gNB. Instead of sending a regular signal, the device backscatters a specific signal pattern that represents its charging status. The gNB, upon receiving this backscattered signal, can decode the pattern and understand the device's charging status.

### Example 2: Modifying Backscattering Capabilities

In another scenario, an A-IoT device is designed with enhanced backscattering capabilities that allow it to backscatter different signal patterns corresponding to different charging statuses. For instance, a certain pattern could indicate that the device is fully charged, while another pattern could indicate that the device needs more charging time. This allows the device to communicate its charging status to the gNB or UE reader directly and efficiently.

### Data Transfer Delay

The gNB or UE reader could delay data transfer with the A-IoT device until it is fully charged. This solution is moderately feasible but requires the gNB or UE reader to manage its data transfer schedule effectively. It ensures that the A-IoT device has sufficient energy for data transfer.

### Example 1: Delaying Data Transfer

Consider an A-IoT device that is currently charging and needs to transfer data to the gNB. Instead of initiating the data transfer immediately, the gNB delays the transfer until the device is fully charged. This ensures that the device has sufficient energy for the data transfer, thus preventing potential energy depletion during the process.

Suppose this device has a power-on time of 0.5 ms, and thus, based on the table provided earlier, it requires 1262 ms to charge by RF. The gNB, upon receiving a communication request from the device, delays the data transfer until the device is fully charged. This means that the gNB will wait for approximately 1262 ms before initiating the data transfer. This ensures that the device has sufficient energy for the data transfer, thus preventing potential energy depletion during the process.

### Example 2: Managing Data Transfer Schedule

In another scenario, the gNB manages its data transfer schedule effectively to ensure efficient communication with multiple A-IoT devices. For instance, the gNB could prioritize data transfer with devices that are fully charged and delay transfer with devices that are still charging. This allows the gNB to ensure efficient data transfer while allowing the devices to charge fully.

Suppose one device with a power-on time of 5 ms requires 12619 ms to charge by RF, while another device with a power-on time of 10 ms requires 25238 ms. The gNB could schedule the data transfer with the first device to occur after 12619 ms and with the second device to occur after 25238 ms. This allows the gNB to ensure efficient data transfer while allowing the devices to charge fully.

These examples illustrate how delaying data transfer until the A-IoT devices are fully charged can ensure efficient communication. The exact implementation would depend on the specific strategies employed by the gNB or UE reader to manage its data transfer schedule. However, the successful implementation of this strategy requires a comprehensive understanding of the A-IoT devices' charging statuses and the ability to manage data transfer schedules effectively.

Implementing the delay of data transfer until the A-IoT device is fully charged can be incorporated into the modified procedures as follows:

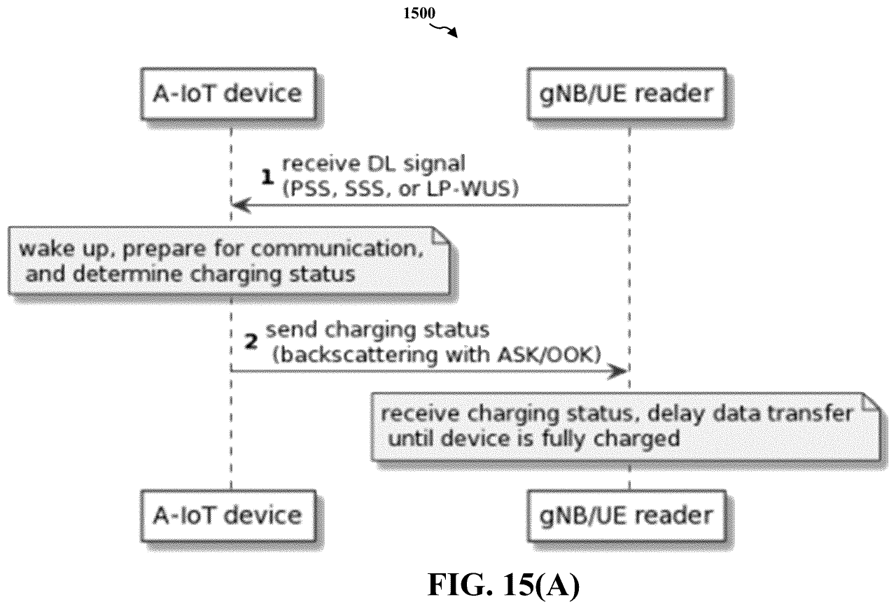

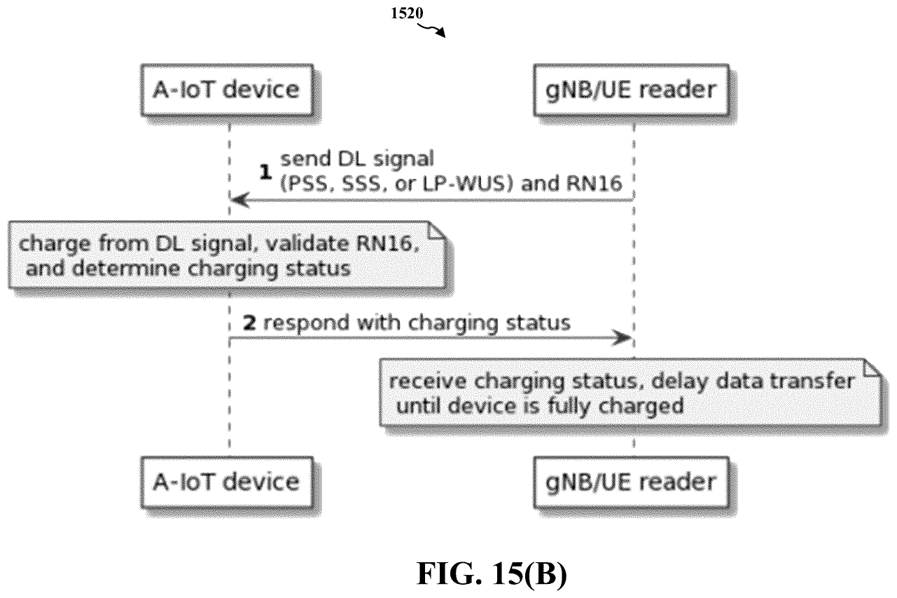

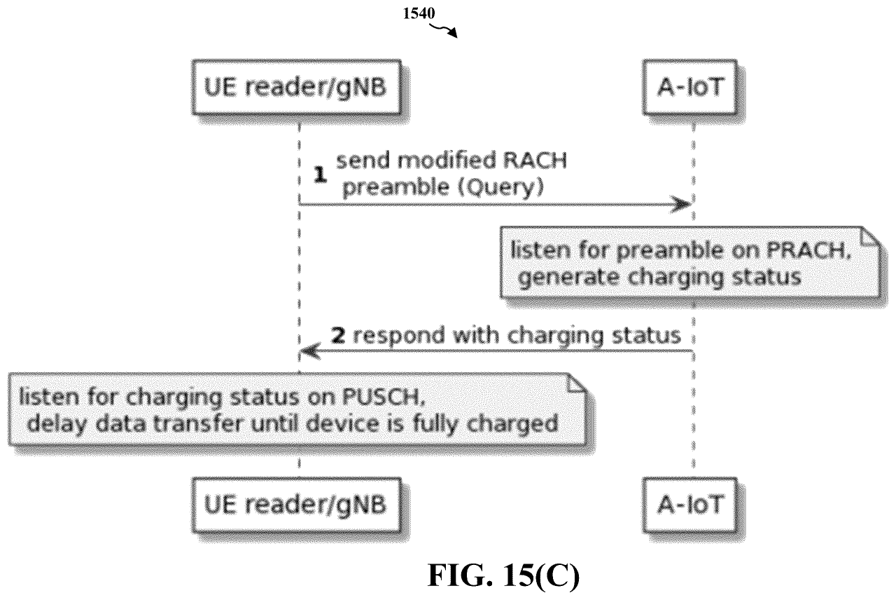

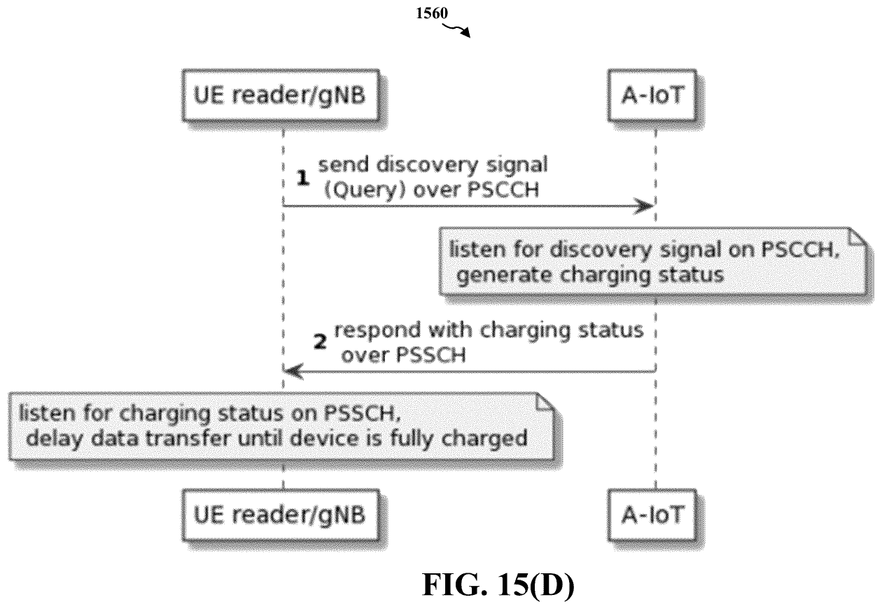

FIG. 15(A) is a sequence diagram 1500 that describes a modified 4-step RACH procedure regarding delaying data transfer. In the modified 4-step RACH procedure, the gNB or UE reader could delay data transfer with the A-IoT device until it is fully charged.

FIG. 15(B) is a sequence diagram 1520 that describes a modified 2-step RACH procedure regarding delaying data transfer. In the modified 2-step RACH procedure, the gNB or UE reader could delay data transfer with the A-IoT device until it is fully charged.

FIG. 15(C) is a sequence diagram 1540 that describes a modified RACH procedure where a UE acts as a tag reader regarding delaying data transfer. In the modified RACH procedure where the UE acts as a tag reader, the UE reader could delay data transfer with the A-IoT device until it is fully charged.

FIG. 15(D) is a sequence diagram 1560 that describes a modified Sidelink procedure regarding delaying data transfer. In the modified Sidelink procedure, the UE reader could delay data transfer with the A-IoT device until it is fully charged.

In all these procedures, the gNB or UE reader would need to be modified to receive the charging status and delay data transfer until the A-IoT device is fully charged. The A-IoT device must also be modified to send its charging status when it is still charging.

### Energy Efficient Protocols

Implementing energy-efficient protocols in RFID systems can significantly reduce per-tag energy consumption. For instance, a strategy such as the Tag-Ordering Polling Protocol (TOP) can minimize energy consumption during the polling process by organizing the tags in an optimal order. This method allows for a trade-off between energy and time, where energy consumption per tag is reduced at the cost of a longer protocol execution time. This solution is less feasible due to the need for substantial changes in the protocol design.

### Example 1: Implementing Tag-Ordering Polling Protocol (TOP)

Consider an RFID system with multiple A-IoT devices that require communication with the gNB or UE reader. By implementing the TOP, the gNB or UE reader organizes the tags in an optimal order, allowing the devices to communicate in a more energy-efficient manner. This reduces the energy consumption per tag, resulting in reduced charging times for the A-IoT devices.

Consider an RFID system with 100 A-IoT devices that require communication with the gNB or UE reader. Without an energy-efficient protocol, let's assume that each device consumes 10 μW of power for communication. Therefore, the total power consumption is 1000 μW.

By implementing the TOP, the gNB or UE reader organizes the tags in an optimal order, potentially reducing the power consumption per tag by 20%. This means each device now consumes only 8 μW of power for communication, reducing the total power consumption to 800 μW. This 20% reduction in power consumption per tag results in a significant reduction in charging time for the A-IoT devices.

### Example 2: Balancing Energy and Time Trade-Offs

In another scenario, the RFID system is designed to balance the trade-off between energy and time. By implementing an energy-efficient protocol such as the TOP, the system can minimize energy consumption per tag, albeit at the cost of a longer protocol execution time. This allows the system to maintain energy efficiency while ensuring that the A-IoT devices have sufficient energy for communication.

By implementing an energy-efficient protocol such as the TOP, the system can minimize power consumption per tag to 8 μW, as in the previous example. However, this comes at the cost of a longer protocol execution time. Suppose the protocol execution time increases by 30% due to the more energy-efficient communication. Despite the longer execution time, the system maintains energy efficiency while ensuring that the A-IoT devices have sufficient power for communication.

The process of organizing the tags in an optimal order by the gNB or UE reader involves determining the sequence of communication with the A-IoT devices that minimizes overall energy consumption. This can be achieved through various strategies, such as prioritizing devices based on their charging status, distance from the reader, or data communication requirements. Here are some examples:

### Example 1: Prioritizing Based on Charging Status

The gNB or UE reader could prioritize communication with devices that are fully charged or near full charge. This would allow these devices to communicate efficiently while using minimal additional energy. Devices that are still charging would be lower in the order, allowing them more time to charge before communicating.

### Example 2: Prioritizing Based on Distance

The gNB or UE reader could also prioritize devices based on their distance from the reader. Devices closer to the reader typically require less energy for communication, so prioritizing these devices could minimize overall energy consumption. Devices further away, which require more energy for communication, would be lower in the order.

### Example 3: Prioritizing Based on Data Communication Requirements

The gNB or UE reader could also consider the data communication requirements of the devices when determining the optimal order. Devices with smaller data packets, which require less energy for transmission, could be prioritized. Devices with larger data packets, which require more energy for transmission, would be lower in the order.

In all these strategies, the goal is to minimize the overall energy consumption of the system by optimally ordering the devices for communication. The exact implementation would depend on the specific characteristics of the devices and the strategies employed by the gNB or UE reader.

The Tag-Ordering Polling Protocol (TOP) can coexist with the Aloha protocol in RFID systems. The Aloha protocol, specifically the Slotted Aloha, is often used in RFID systems for tag identification. However, it can lead to collisions when multiple tags respond simultaneously.

TOP can be integrated with the Aloha protocol to reduce collisions and improve energy efficiency. Here's how it can be done:

Step 1: Initial Identification with Aloha

The gNB or UE reader uses the Slotted Aloha protocol for initial identification of the tags. During this process, each A-IoT device randomly selects a time slot to avoid collision.

Step 2: Tag Ordering with TOP

Once the initial identification is completed, the gNB or UE reader uses the TOP to order the tags based on the criteria such as charging status, distance, or data communication requirements. The gNB or UE reader then communicates with the tags based on this order.

Step 3: Communication with Ordered Tags

The gNB or UE reader communicates with the A-IoT devices based on the order determined in Step 2. Since the order is known, the devices do not need to randomly select a time slot for response, reducing the chance of collision and improving energy efficiency.

### Step 4: Repeating the Process

The process is repeated periodically to update the tag order and accommodate new tags or changes in the status of existing tags.

By integrating TOP with the Aloha protocol, RFID systems can maintain the benefits of tag identification offered by Aloha while improving energy efficiency and reducing collisions with TOP. This coexistence allows for efficient management of multiple A-IoT devices and ensures effective communication with each device.

Implementing the use of energy-efficient protocols like the Tag-Ordering Polling Protocol (TOP) in the modified procedures can be done as follows:

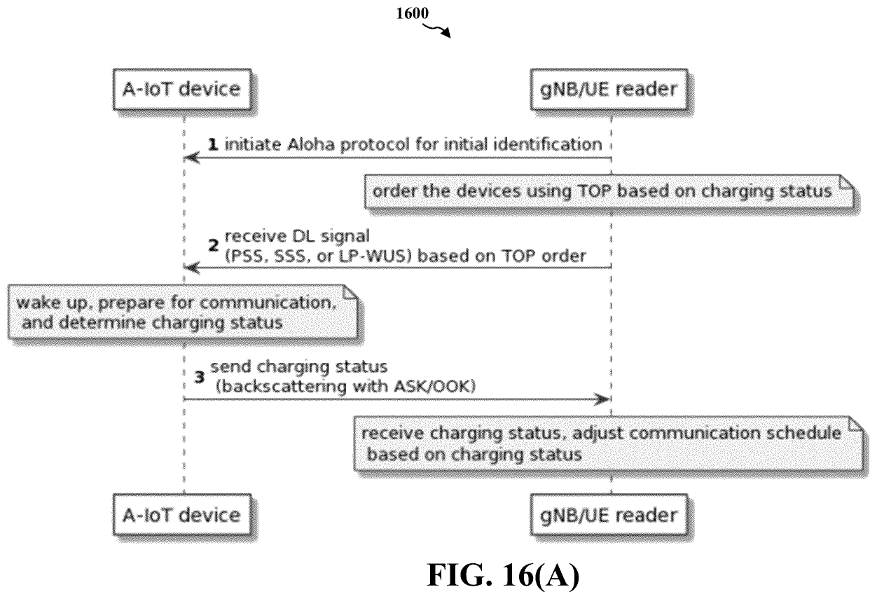

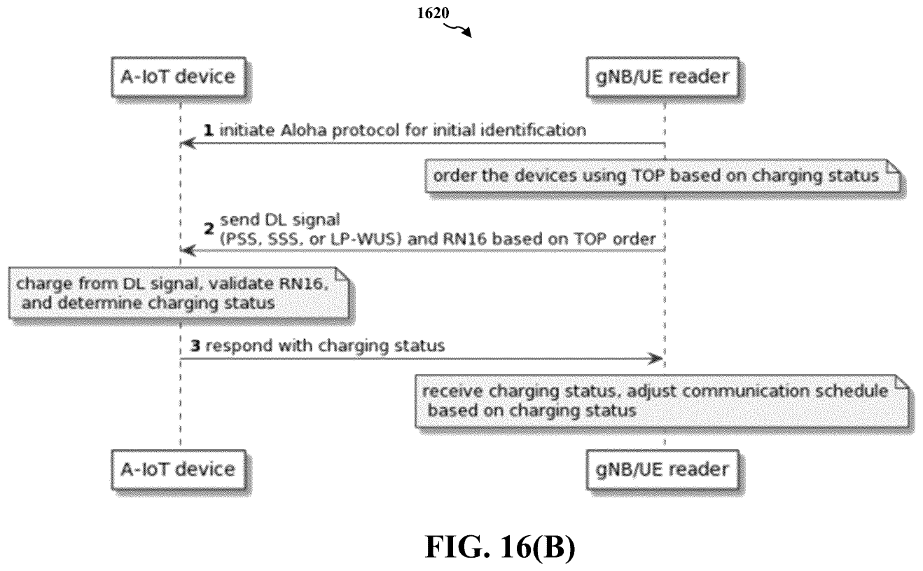

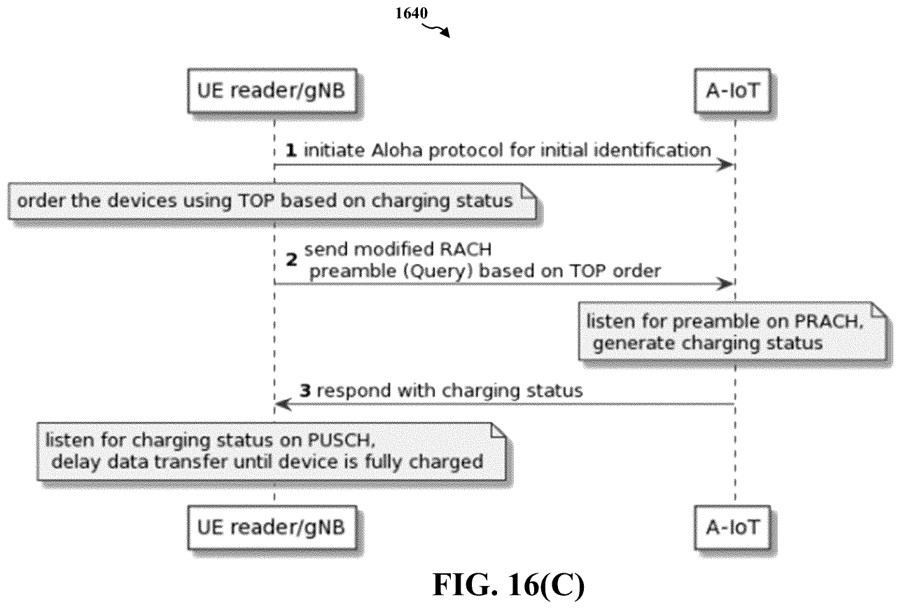

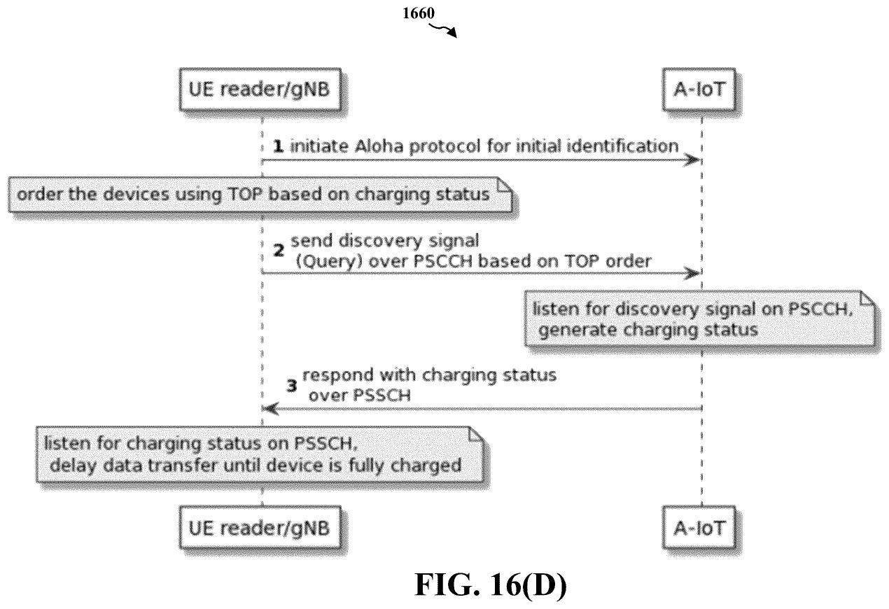

FIG. 16(A) is a sequence diagram 1600 that describes a modified 4-step RACH procedure regarding energy efficient protocols. In the modified 4-step RACH procedure, the gNB or UE reader could use the TOP to order the A-IoT devices based on their charging status before initiating communication.

FIG. 16(B) is a sequence diagram 1620 that describes a modified 2-step RACH procedure regarding energy efficient protocols. In the modified 2-step RACH procedure, the gNB or UE reader could use the TOP to order the A-IoT devices based on their charging status before initiating communication.

FIG. 16(C) is a sequence diagram 1640 that describes a modified RACH procedure where a UE acts as a tag reader regarding energy efficient protocols. In the modified RACH procedure where the UE acts as a tag reader, the UE reader could use the TOP to order the A-IoT devices based on their charging status before initiating communication.

FIG. 16(D) is a sequence diagram 1660 that describes a modified Sidelink procedure regarding energy efficient protocols. In the modified Sidelink procedure, the UE reader could use the TOP to order the A-IoT devices based on their charging status before initiating communication.

In all these procedures, the gNB or UE reader would need to be modified to implement the Aloha protocol for initial identification and the TOP for ordering the A-IoT devices. The A-IoT devices must also be modified to respond to the Aloha protocol and communicate their charging status.

In a first aspect, a user equipment (UE), including:
one or more non-transitory computer-readable media having computer-executable instructions embodied thereon, and at least one processor coupled to the one or more non-transitory computer-readable media and configured to execute the computer-executable instructions to:

Receive from a base station (BS), a Downlink (DL) signal, if the UE is in a state of readiness for communication.

Determine a unique, shorter signal representing its charging status, if the DL signal is received. The charging status is represented as a binary string of a specific length, with each bit or group of bits representing a different aspect of the charging status, such as the charging state, battery level, and estimated time to full charge.

Perform a modification in the 4-step RACH procedure, if the DL signal is received. The modification involves sending the shorter charging status message instead of the RN16 after receiving the DL signal from the BS.

Transmit, to the BS, the shorter charging status message in response to the DL signal, if the charging status is determined.

In a second aspect, a user equipment (UE), including:
one or more non-transitory computer-readable media having computer-executable instructions embodied thereon, and at least one processor coupled to the one or more non-transitory computer-readable media and configured to execute the computer-executable instructions to:

Receive from a base station (BS), a wake-up signal indicating the device's readiness for further communication.

Determine a unique, shorter signal that represents its charging status, if the wake-up signal is received. The charging status could be represented as a binary string of 8 bits, divided into different sections: Charging State, Battery Level, and Time to Full Charge.

Perform a modification in the communication schedule, if the charging status message is received. The modification involves adjusting the communication schedule based on the received charging status message.

Transmit, to the BS, the shorter charging status message in response to a wake-up signal from the BS, if the charging status is determined. This approach allows for efficient communication while ensuring that the A-IoT device's energy status is accurately communicated.

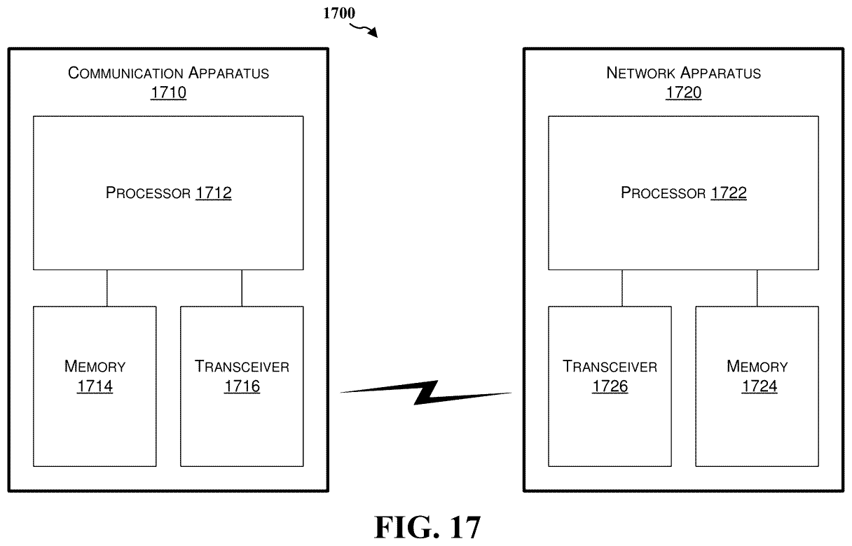

FIG. 17 illustrates an example communication system 1700 having an example communication apparatus 1710 and an example network apparatus 1720 in accordance with an implementation of the present disclosure. Each of communication apparatus 1710 and network apparatus 1720 may perform various functions to implement schemes, techniques, processes and methods described herein pertaining to using on-demand reference signal for network energy saving with respect to user equipment and network apparatus in mobile communications, including scenarios/schemes described above as well as processes 1800 and 1900 described below.

Communication apparatus 1710 may be a part of an electronic apparatus, which may be a UE such as a portable or mobile apparatus, a wearable apparatus, a wireless communication apparatus or a computing apparatus. For instance, communication apparatus 1710 may be implemented in a smartphone, a smartwatch, a personal digital assistant, a digital camera, or a computing equipment such as a tablet computer, a laptop computer or a notebook computer. Communication apparatus 1710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 1710 may be implemented in a smart thermostat, a smart fridge, a smart door lock, a wireless speaker or a home control center. Alternatively, communication apparatus 1710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 1710 may include at least some of those components shown in FIG. 17 such as a processor 1712, for example. Communication apparatus 1710 may further include one or more other components not pertinent to the proposed scheme of the present disclosure (e.g., internal power supply, display device and/or user interface device), and, thus, such component(s) of communication apparatus 1710 are neither shown in FIG. 17 nor described below in the interest of simplicity and brevity.

Network apparatus 1720 may be a part of a network apparatus, which may be a network node such as a satellite, a base station, a small cell, a router or a gateway. For instance, network apparatus 1720 may be implemented in an eNodeB in an LTE network, in a gNB in a 5G/NR, IoT, NB-IoT or IIOT network or in a satellite or base station in a 6G network. Alternatively, network apparatus 1720 may be implemented in the form of one or more IC chips such as, for example and without limitation, one or more single-core processors, one or more multi-core processors, or one or more RISC or CISC processors. Network apparatus 1720 may include at least some of those components shown in FIG. 17 such as a processor 1722, for example. Network apparatus 1720 may further include one or more other components not pertinent to the proposed scheme of the present disclosure (e.g., internal power supply, display device and/or user interface device), and, thus, such component(s) of network apparatus 1720 are neither shown in FIG. 17 nor described below in the interest of simplicity and brevity.

In one aspect, each of processor 1712 and processor 1722 may be implemented in the form of one or more single-core processors, one or more multi-core processors, or one or more CISC processors. That is, even though a singular term “a processor” is used herein to refer to processor 1712 and processor 1722, each of processor 1712 and processor 1722 may include multiple processors in some implementations and a single processor in other implementations in accordance with the present disclosure. In another aspect, each of processor 1712 and processor 1722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1712 and processor 1722 is a special-purpose machine specifically designed, arranged and configured to perform specific tasks including autonomous reliability enhancements in a device (e.g., as represented by communication apparatus 1710) and a network (e.g., as represented by network apparatus 1720) in accordance with various implementations of the present disclosure.

In some implementations, communication apparatus 1710 may also include a transceiver 1716 coupled to processor 1712 and capable of wirelessly transmitting and receiving data. In some implementations, communication apparatus 1710 may further include a memory 1714 coupled to processor 1712 and capable of being accessed by processor 1712 and storing data therein. In some implementations, network apparatus 1720 may also include a transceiver 1726 coupled to processor 1722 and capable of wirelessly transmitting and receiving data. In some implementations, network apparatus 1720 may further include a memory 1724 coupled to processor 1722 and capable of being accessed by processor 1722 and storing data therein. Accordingly, communication apparatus 1710 and network apparatus 1720 may wirelessly communicate with each other via transceiver 1716 and transceiver 1726, respectively. To aid better understanding, the following description of the operations, functionalities and capabilities of each of communication apparatus 1710 and network apparatus 1720 is provided in the context of a mobile communication environment in which communication apparatus 1710 is implemented in or as a communication apparatus or a UE and network apparatus 1720 is implemented in or as a network node of a communication network.

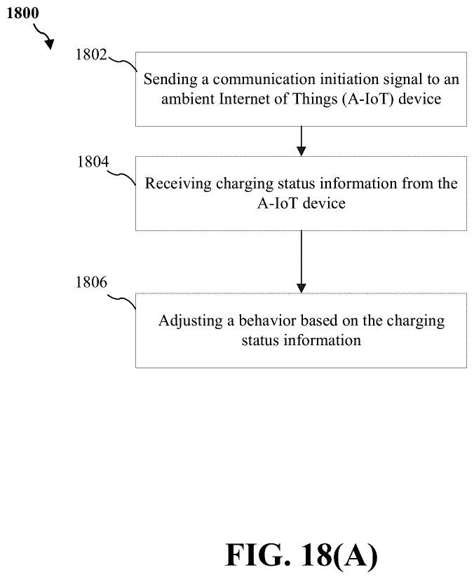

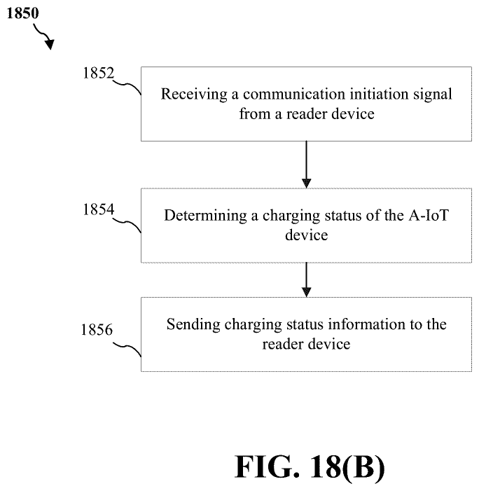

FIG. 18(A) is a flow chart 1800 of a process for handling the charging time regarding a reader device and an A-IoT device. This process involves interactions between a gNB, a UE (e.g., the UE 744), and an ambient Internet of Things (A-IoT) device (e.g., the A-IoT device 746).

At block 1802, a reader device may send a communication initiation signal to an ambient Internet of Things (A-IoT) device. The reader device may be the UE 744 or the gNB.

Then, at block 1804, the reader device, e.g., the UE 744, may receive charging status information from the A-IoT device.

Finally, at block 1806, the reader device may adjust a behavior based on the charging status information.

In some embodiments, the charging status information may be included in a random 16-bit number (RN16) received from the A-IoT device, or in a charging status message shorter than the RN16.

In some embodiments, the communication initiation signal may include a downlink signal, and the process may further include: sending the RN16 to the A-IoT device along with the downlink signal. In some embodiments, the downlink signal may include one of: a primary synchronization signal (PSS), a secondary synchronization signal (SSS), or a low power wake-up signal (LP-WUS).

In some embodiments, the communication initiation signal may include a random access channel (RACH) preamble, and the process may further include: listening for the RN16 or the charging status message on a physical uplink shared channel (PUSCH).

In some embodiments, the communication initiation signal may include a discovery signal over a physical sidelink control channel (PSCCH), and the process may further include: listening for the RN16 or the charging status message on a physical sidelink shared channel (PSSCH).

In some embodiments, the charging status message may include a binary string including multiple sections respectively indicating: a charging state indicating whether the A-IoT device is currently charging, fully charged, or not charging; a battery level representing a current level of the A-IoT device's battery or energy storage; and a time to full charge. In some embodiments, the RN16 comprises multiple bits respectively indicating the charging state, the battery level, and the time to full charge.

In some embodiments, adjusting the behavior may include at least one of: adjusting a communication schedule; sending an acknowledgment signal to the A-IoT device to confirm reception of the charging status information; initiating further communication; monitoring signals from the A-IoT device; or proceeding with other tasks.

FIG. 18(B) is a flow chart 1850 of another process for handling the charging time regarding a reader device and an A-IoT device.

At block 1852, an A-IoT device, e.g., the A-IoT device 746, may receive a communication initiation signal from a reader device. The reader device, may be a UE, e.g., the UE 744, or a gNB.

Then, at block 1854, the A-IoT device 746 may determine a charging status of the A-IoT device.

Finally, at block 1856, the A-IoT device 746 may send charging status information to the reader device.

In some embodiments, the charging status information may be included in a random 16-bit number (RN16), or in a charging status message shorter than the RN16.

In some embodiments, the A-IoT device may send the charging status message when an energy level of the A-IoT device is insufficient for backscattering communication; and the A-IoT device may send the RN16 when the energy level is sufficient for backscattering communication.

In some embodiments, the A-IoT device may send the charging status message when there is a change in a charging state of the A-IoT device; and the A-IoT device may send the RN16 when there is no change in the charging state of the A-IoT device.

In some embodiments, the communication initiation signal may include a downlink signal received along with a random 16-bit number (RN16) from the reader device. In some embodiments, the downlink signal comprises one of: a primary synchronization signal (PSS), a secondary synchronization signal (SSS), or a low power wake-up signal (LP-WUS).

In some embodiments, the communication initiation signal may include a random access channel (RACH) preamble, and the process may further include: listening for the preamble on a physical random access channel (PRACH); generating the charging status message or incorporating the charging status information into the RN16.

In some embodiments, the communication initiation signal may include a discovery signal received over a physical sidelink control channel (PSCCH), and the process may further include: listening for the discovery signal on the PSCCH; generating the charging status message or incorporating the charging status information into the RN16.

In some embodiments, the A-IoT device may send the RN16 or the charging status message by using backscattering communication with amplitude shift keying (ASK) or on-off keying (OOK) modulation.

In some embodiments, the charging status message may include a binary string including multiple sections respectively indicating: a charging state indicating whether the A-IoT device is currently charging, fully charged, or not charging; a battery level representing a current level of the A-IoT device's battery or energy storage; and a time to full charge; and the RN16 comprises multiple bits respectively indicating the charging state, the battery level, and the time to full charge.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a reader device, comprising:
sending a communication initiation signal to an ambient Internet of Things (A-IoT) device;
receiving charging status information from the A-IoT device; and
adjusting a behavior based on the charging status information.

2. The method of claim 1, wherein the charging status information is included in a random 16-bit number (RN16) received from the A-IoT device, or in a charging status message shorter than the RN16.

3. The method of claim 2, wherein the communication initiation signal comprises a downlink signal, and further comprising:
sending the RN16 to the A-IoT device along with the downlink signal.

4. The method of claim 3, wherein the downlink signal comprises one of:
a primary synchronization signal (PSS),
a secondary synchronization signal (SSS), or
a low power wake-up signal (LP-WUS).

5. The method of claim 2, wherein the communication initiation signal comprises a random access channel (RACH) preamble, and further comprising:
listening for the RN16 or the charging status message on a physical uplink shared channel (PUSCH).

6. The method of claim 2, wherein the communication initiation signal comprises a discovery signal over a physical sidelink control channel (PSCCH), and further comprising:
listening for the RN16 or the charging status message on a physical sidelink shared channel (PSSCH).

7. The method of claim 2, wherein:
the charging status message comprises a binary string including multiple sections respectively indicating:
a charging state indicating whether the A-IoT device is currently charging, fully charged, or not charging;
a battery level representing a current level of the A-IoT device's battery or energy storage; and
a time to full charge; and/or
the RN16 comprises multiple bits respectively indicating the charging state, the battery level, and the time to full charge.

8. The method of claim 1, wherein adjusting the behavior comprises at least one of:
adjusting a communication schedule;
sending an acknowledgment signal to the A-IoT device to confirm reception of the charging status information;
initiating further communication;
monitoring signals from the A-IoT device; or
proceeding with other tasks.

9. A method of wireless communication by an ambient Internet of Things (A-IoT) device, comprising:
receiving a communication initiation signal from a reader device;
determining a charging status of the A-IoT device; and
sending charging status information to the reader device.

10. The method of claim 9, wherein the charging status information is included in a random 16-bit number (RN16), or in a charging status message shorter than the RN16.

11. The method of claim 10, wherein:
the A-IoT device sends the charging status message when an energy level of the A-IoT device is insufficient for backscattering communication; and
the A-IoT device sends the RN16 when the energy level is sufficient for backscattering communication.

12. The method of claim 10, wherein:
the A-IoT device sends the charging status message when there is a change in a charging state of the A-IoT device; and
the A-IoT device sends the RN16 when there is no change in the charging state of the A-IoT device.

13. The method of claim 10, wherein the communication initiation signal comprises a downlink signal received along with a random 16-bit number (RN16) from the reader device.

14. The method of claim 13, wherein the downlink signal comprises one of:
a primary synchronization signal (PSS),
a secondary synchronization signal (SSS), or
a low power wake-up signal (LP-WUS).

15. The method of claim 10, wherein the communication initiation signal comprises a random access channel (RACH) preamble, and further comprising:
listening for the preamble on a physical random access channel (PRACH); and
generating the charging status message or incorporating the charging status information into the RN16.

16. The method of claim 10, wherein the communication initiation signal comprises a discovery signal received over a physical sidelink control channel (PSCCH), and further comprising:
listening for the discovery signal on the PSCCH; and
generating the charging status message or incorporating the charging status information into the RN16.

17. The method of claim 10, wherein the A-IoT device sends the RN16 or the charging status message by using backscattering communication with amplitude shift keying (ASK) or on-off keying (OOK) modulation.

18. The method of claim 10, wherein:
the charging status message comprises a binary string including multiple sections respectively indicating:
a charging state indicating whether the A-IoT device is currently charging, fully charged, or not charging;
a battery level representing a current level of the A-IoT device's battery or energy storage; and
a time to full charge; and/or
the RN16 comprises multiple bits respectively indicating the charging state, the battery level, and the time to full charge.

19. The method of claim 9, further comprising:
receiving an acknowledgment signal from the reader device to confirm the charging status information has been received.

20. An apparatus for wireless communication, the apparatus being an ambient Internet of Things (A-IoT) device, comprising:
a memory; and
at least one processor coupled to the memory and configured to:
receive a communication initiation signal from a reader device;
determine a charging status of the A-IoT device; and
send charging status information to the reader device.
